(19) United States
(12) Patent Application Publication
(10) Pub. No.: US 2009/0239617 A1
(43) Pub. Date: Sep. 24, 2009

(54) Slot Machine

(75) Inventor: Norio HOSOKAWA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: Aruze Corp., Tokyo (JP)

(21) Appl. No.: 12/206,168

(22) Filed: Sep. 8, 2008

Related U.S. Application Data
(60) Provisional application No. 61/038,941, filed on Mar. 24, 2008.

(51) Int. Cl. A63F 9/24; A63F 13/00

(52) U.S. Cl. 463/20

(57) ABSTRACT

A slot machine of the present invention has a controller for controlling a display device, an input device, and a display unit. The controller is operable to: (a) store in the memory a predetermined combination of the input numbers via the input device; (b) execute a process of displaying the combination of the numbers stored in the memory on the display unit; (c) execute a basic game; (d) rearrange in the display region the plurality of symbols with a plurality of numbers assigned thereto during the basic game; (e) pay out a payment in a case where a combination of the rearranged symbols is a predetermined combination; and (f) pay out a payment, in a case where a combination of numbers assigned to the symbols rearranged on a winning line of the display region coincides with the combination of numbers stored in the memory.

### CROSS-REFERENCE TO RELATED APPLICATIONS

This application claims priority of U.S. Provisional Application No. 61/038.941 filed on Mar. 24, 2008. The contents of this application are incorporated herein by reference in their entirety.

### BACKGROUND OF THE INVENTION

1. Field of the Invention

The present invention relates to a slot machine.

2. Description of the Related Art

In a conventional slot machine, when a player inserts a game medium, such as a coin and a bill, in an insertion slot of a slot machine and presses a SPIN button, a display provided on a front face of a cabinet displays a plurality of symbols in a scrolling manner. Then, scrolling of each of the symbols automatically stops.

As such a slot machine, for example, as disclosed in U.S. Pat. No. 6,093,102, a slot machine exists which employs a concept of a winning line. In this concept, in a case where a combination of symbols rearranged on a winning line is a predetermined winning combination, a predetermined number of game media are paid out.

In addition, as such a slot machine, for example, as disclosed in each of U.S. Pat. No. 6,604,999 and U.S. Patent Publication No. 2002/0065124, a slot machine exists which provides two types of payouts, including a payout determined by a combination of symbols rearranged on a winning line and a payout determined by a number of displayed scatter symbols.

With conventional slot machines, however, a player has no option other than starting and stopping the scrolling of symbols in association with a slot game. Owing to repetition of the monotonous game play for a long period of time a player tends to grow tired of the game. Further, with conventional slot machines, a player cannot be involved in the winning or loss of the game, and thus, even if a player had won a game, a player is not able to feel they had won using only their own power, and had little entertainability.

The present invention has been made in view of the above-described circumstance which can offer entertainability to players that has not been successfully attained by those of the aforementioned conventional art.

### SUMMARY OF THE INVENTION

A first aspect of the present invention is a slot machine including: a display device having a display region for displaying plural types of symbols with plural types of numbers assigned thereto; an input device for inputting numbers that correspond to the plural types of numbers assigned to the symbols; a memory which stores a combination of the numbers inputted via the input device; a display unit for displaying a combination of the numbers input by the input device; a controller for controlling the display device, the input device, and the display unit. The controller is programmed to: (a) store in the memory a predetermined combination of the numbers inputted via the input device (b) execute a process of displaying the combination of the numbers stored in the memory on the display unit (c) execute a basic game (d) rearrange in the display region the plurality of symbols with plural types of numbers assigned thereto during the basic game (e) pay out a payment in a case where a combination of the rearranged symbols is a predetermined combination (f) pay out a payment, in a case where a combination of numbers assigned to the symbols rearranged on a winning line of the display region coincides with the combination of numbers stored in the memory.

According to the first aspect constituted as set forth above, it is possible to predict and input a specific number from a plurality of numbers assigned to symbols. A payout is paid not only when symbols rearranged on a winning line form a predetermined combination of symbols, but also when a combination of symbols rearranged on a winning line coincides with inputted numbers. Therefore, by predicting symbols, players are able to engage in the payout. Further, a novel slot machine can be provided which allows players to enjoy new entertainability in addition to conventional entertainability.

A second aspect of the present invention is a slot machine of the first aspect, further comprising a BET button, which accepts input of a side BET, wherein the controller executes a process of displaying the numbers input by the input device on the display unit in a state in which the inputted numbers are writable in the memory on condition that the side BET is input from the BET button in the processes (a) and (b).

According to the second aspect constituted as set forth above, on condition that a side BET is inputted, it is possible to predict and input specific numbers from a plurality of numbers. A payout is paid not only when symbols rearranged on a winning line forms a predetermined combination of symbols, but also when a combination of symbols rearranged on a winning line coincides with inputted numbers. Therefore, by predicting symbols, players are able to engage in the payout. Further, a novel slot machine can be provided which allows players to enjoy new entertainability in addition to conventional entertainability.

A third aspect of the present invention is the slot machine of the first aspect, wherein the controller judges coincidence of combinations of the numbers in the process (f) while a plurality of preset symbols are rearranged for a plurality of times preset as to input of a side BET of a predetermined credit by the BET button.

According to the third aspect constituted as set forth above, on condition that a predetermined credit of a side bet is inputted, a specific number can be predicted and inputted from a plurality of numbers assigned to symbols. A payout is paid not only when symbols rearranged on a winning line forms a predetermined combination of symbols, but also when a combination of symbols rearranged on a winning line coincides with inputted numbers. Therefore, by predicting symbols, players are able to engage in the payout. Further, a novel slot machine can be provided which allows players to enjoy new entertainability in addition to conventional entertainability.

A fourth aspect of the invention is the game machine of the first aspect, wherein the controller validates input of the BET button for randomly accepting the side BET during the basic game.

According to the fourth aspect constituted as set forth above, the bet button becomes available to be randomly inputted during the basic game, and it is possible to predict and input a specific number out of a plurality of numbers assigned to symbols. A payout is paid not only when symbols rearranged on a winning line form a predetermined combination of symbols, but also when a combination of symbols rearranged on a winning line coincides with inputted numbers. Therefore, by predicting symbols, players are able to engage in the payout. Further, a novel slot machine can be provided which allows players to enjoy new entertainability in addition to conventional entertainability.

A fifth aspect of the invention is the game machine of the first aspect, wherein the controller is programmed to (g) execute a free game during the basic game and (h) rearrange plural types of symbols to which the plural types of numbers are assigned, in the display region during the free game and wherein the controller executes the process (f) during the basic game.

According to the fifth aspect constituted as set forth above, it is possible to predict and input a specific number out of a plurality of numbers assigned to symbols during a free game. A payout is paid not only when symbols rearranged on a winning line is a predetermined combination of symbols, but also when a combination of symbols rearranged on a winning line coincides with inputted numbers. Therefore, by predicting symbols, players are able to engage in the payout. Further, a novel slot machine can be provided which allows players to enjoy new entertainability in addition to conventional entertainability.

A sixth aspect of the present invention is a slot machine including: a display device having a display region for displaying plural types of symbols with a plurality of numbers assigned thereto; an input device for inputting numbers that correspond to the plural types of numbers assigned to the symbols; a memory which stores a combination of the numbers inputted via the input device; a bet button which accepts input of a side BET; a display unit for displaying a combination of the numbers input by the input device; a BET button which accepts input of a side BET; a controller for controlling the display device, the input device, the display unit, and the BET button; The controller is programmed to: (a) store a predetermined combination of the numbers inputted via the input device in the memory on condition that the side BET is inputted from the BET button (b) execute a process of displaying the combination of the numbers stored in the memory on the display unit on condition that the side BET is inputted from the BET button (c) execute a basic game (d) rearrange in the display region the plurality of symbols with a plurality of numbers assigned thereto during the basic game (e) pay out a payment in a case where a combination of the rearranged symbols is a predetermined combination (f) pay out a payment, in a case where a combination of numbers assigned to the symbols rearranged on a winning line of the display region coincides with the combination of numbers stored in the memory.

According to the sixth aspect constituted as set forth above, on condition that a side BET is inputted, it is possible to predict and input a specific number out of a plurality of numbers assigned to symbols. A payout is paid not only when symbols rearranged on a winning line form a predetermined combination of symbols, but also when a combination of symbols rearranged on a winning line coincides with inputted numbers. Therefore, by predicting symbols, players are able to engage in the payout. Further, a novel slot machine can be provided which allows players to enjoy new entertainability in addition to conventional entertainability.

A seventh aspect of the invention is the game machine of the sixth aspect, wherein the controller judges coincidence of combinations of the numbers in the process (f) while the symbols are rearranged for a plurality of times preset as to input of a side BET of a predetermined credit by the BET button.

According to the seventh aspect constituted as set forth above, on condition that predetermined credits of a side bet are inputted, it is possible to predict and input a specific number out of a plurality of numbers assigned to symbols. A payout is paid not only when symbols rearranged on a winning line form a predetermined combination of symbols, but also when a combination of symbols rearranged on a winning line coincides with inputted numbers. Therefore, by predicting symbols, players are able to engage in the payout. Further, a novel slot machine can be provided which allows players to enjoy new entertainability in addition to conventional entertainability.

An eighth aspect of the invention is the game machine of the sixth aspect, wherein the controller validates input of the BET button for randomly accepting the side BET during the basic game.

According to the eighth aspect constituted as set forth above, the bet button is randomly activated and it is possible to predict and input a specific number out of a plurality of numbers assigned to symbols. A payout is paid not only when symbols rearranged on a winning line form a predetermined combination of symbols, but also when a combination of symbols rearranged on a winning line coincides with inputted numbers. Therefore, by predicting symbols, players are able to engage in the payout. Further, a novel slot machine can be provided which allows players to enjoy new entertainability in addition to conventional entertainability.

A ninth aspect of the invention is the game machine of the sixth aspect, wherein the controller is programmed to (g) execute a free game during the basic game; and (h) rearrange plural types of symbols to which the plural types of numbers are assigned, in the display region during the free game and wherein the controller executes the process (f) during the basic game.

According to the ninth aspect constituted as set forth above, it is possible to predict and input a specific number out of a plurality of numbers assigned to symbols during a free game. A payout is paid not only when symbols rearranged on a winning line form a predetermined combination of symbols, but also when a combination of symbols rearranged on a winning line coincides with inputted numbers. Therefore, by predicting symbols, players are able to engage in the payout. Further, a novel slot machine can be provided which allows players to enjoy new entertainability in addition to conventional entertainability.

A tenth aspect of the present invention is a slot machine including: a display device having a display region for displaying plural types of symbols with a plurality of numbers assigned thereto; an input device for inputting numbers that correspond to the plural types of numbers assigned to the symbols; a memory which stores a combination of the numbers inputted via the input device; a display unit for displaying a combination of the numbers input by the input device;
a BET button which accepts input of a side BET; a controller for controlling the display device, the input device, the display unit and the BET button. The controller is programmed to: (a) store a predetermined combination of numbers inputted by the input device on condition that the side BET is inputted from the BET button (b) execute a process of displaying the combination of the numbers stored in the memory on the display unit on condition that the side BET is inputted from the BET button (c) execute a basic game (d) rearrange in the display region the plurality of symbols with a plural types of numbers assigned thereto during the basic game (e) pay out a payment in a case where a combination of the rearranged symbols is a predetermined combination and (f) pay out a payment, in a case where a combination of numbers assigned to symbols rearranged on a winning line of the display region coincides with the combination of the numbers stored in the memory while a predetermined number of symbols are rearranged as to input of a side BET of a predetermined credit by the BET button.

According to the tenth aspect constituted as set forth above, on condition that predetermined credits of a side BET are inputted, it is possible to predict and input a specific number out of a plurality of numbers assigned to symbols. A payout is paid not only when symbols rearranged on a winning line form a predetermined combination of symbols, but also when a combination of symbols rearranged on a winning line coincides with inputted numbers. Therefore, by predicting symbols, players are able to engage in the payout. Further, a novel slot machine can be provided which allows players to enjoy new entertainability in addition to conventional entertainability.

An eleventh aspect of the invention is the game machine of the tenth aspect, wherein the controller validates input of the BET button for randomly accepting the side BET during the basic game.

According to the eleventh aspect constituted as set forth above, it is possible to predict and input a specific number out of a plurality of numbers assigned to symbols during a basic game. A payout is paid not only when symbols rearranged on a winning line form a predetermined combination of symbols, but also when a combination of symbols rearranged on a winning line coincides with inputted numbers. Therefore, by predicting symbols, players are able to engage in the payout. Further, a novel slot machine can be provided which allows players to enjoy new entertainability in addition to conventional entertainability.

An eleventh aspect of the invention is the game machine of the tenth aspect, wherein the controller is programmed to (g) execute a free game during the basic game and (h) rearrange plural types of symbols to which the plural types of numbers are assigned, in the display region during the free game; and wherein the controller executes the process (f) during the basic game.

According to the twelfth aspect constituted as set forth above, it is possible to predict and input a specific number out of plural types of numbers assigned to symbols, during a free game. A payout is paid not only when symbols rearranged on a winning line form a predetermined combination of symbols, but also when a combination of symbols rearranged on a winning line coincides with inputted numbers. Therefore, by predicting symbols, players are able to engage in the payout. Further, a novel slot machine can be provided which allows players to enjoy new entertainability in addition to conventional entertainability.

### BRIEF DESCRIPTION OF THE DRAWINGS

FIG. 1 is a view showing an exemplary symbol matrix during a symbol matrix according to a first embodiment;

FIG. 2 is a perspective view schematically showing a slot machine according to the first embodiment;

FIG. 3 is a view showing an internal construction of the slot machine shown in FIG. 2;

FIG. 4A is a view showing an exemplary symbol matrix displayed in the slot machine shown in FIG. 2 during the basic game according to the first embodiment;

FIG. 4B is a view showing an exemplary symbol matrix displayed in the slot machine shown in FIG. 2 during the basic game according to the first embodiment;

FIG. 5A is a view showing an exemplary image displayed in the slot machine shown in FIG. 2 during the basic game according to the first embodiment;

FIG. 5B is a view showing an exemplary symbol matrix displayed in the slot machine shown in FIG. 2 during the basic game according to the first embodiment;

FIG. 6A is a view showing an exemplary image displayed in the slot machine shown in FIG. 2 during a free game according to the first embodiment;

FIG. 6B is a view showing an exemplary symbol matrix displayed in the slot machine shown in FIG. 2 during the free game according to the first embodiment;

FIG. 7A is a view showing an exemplary image displayed in the slot machine shown in FIG. 2 during a jackpot bonus game according to the first embodiment;

FIG. 7B is a view showing an exemplary image displayed in the slot machine shown in FIG. 2 during the jackpot bonus game according to the first embodiment;

FIG. 8A is a view showing an exemplary image displayed in the slot machine shown in FIG. 2 during the jackpot bonus game according to the first embodiment;

FIG. 8B is a view showing an exemplary image displayed in the slot machine shown in FIG. 2 during the jackpot bonus game according to the first embodiment;

FIG. 9A is a view showing an exemplary image displayed in the slot machine shown in FIG. 2 during the jackpot bonus game according to the first embodiment;

FIG. 9B is a view showing an exemplary image displayed in the slot machine shown in FIG. 2 during the jackpot bonus game according to the first embodiment;

FIG. 10 is a flowchart showing a subroutine of main process according to the first embodiment;

FIG. 11 is a flowchart showing a subroutine of a game execution process according to the first embodiment;

FIG. 12 is a flowchart showing a subroutine of a symbol selection program according to the first embodiment;

FIG. 13 is a flowchart showing a subroutine of a free game execution process according to the first embodiment;

FIG. 14 is a flowchart showing a subroutine of a jackpot bonus game execution process according to the first embodiment;

FIG. 15 is a view for schematically showing an appearance of the slot machine according to a second embodiment of the present invention;

FIG. 16 is a flowchart showing a subroutine of a game execution process according to a second embodiment; and

FIG. 17 is a flowchart showing a subroutine of a symbol selection program according to the second embodiment.

### DESCRIPTION OF THE PREFERRED EMBODIMENTS

First, a slot machine 10 according to a first embodiment will be described in detail with reference to the drawings. The slot machine according to the first embodiment is a so-called video slot machine, which has an image display panel such as a liquid crystal display and executes a game by displaying images of various symbols on the image display panel.

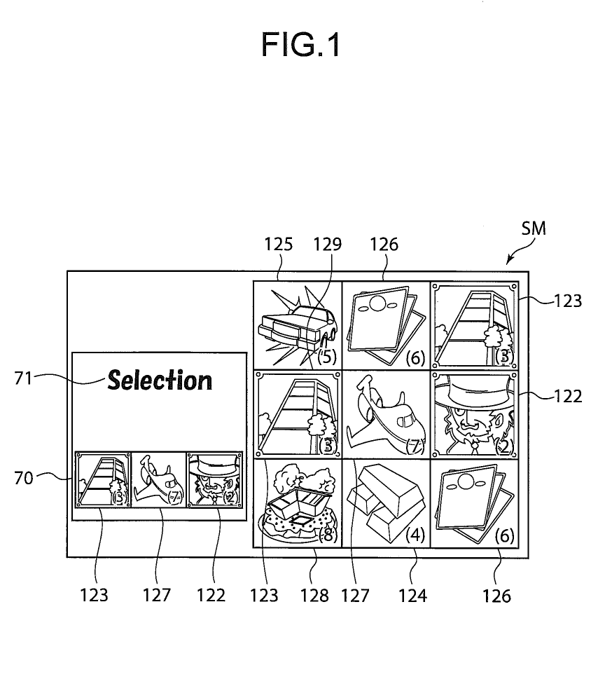

FIG. 1 is a view showing an exemplary symbol matrix of a basic game according to a first embodiment. The slot machine 10 according to the present invention executes any one of three types of gaming modes including a basic game, a free game, and a progressive bonus game. The basic game is executed upon consuming a gaming value corresponding to the amount bet by a player. The free game is executed without consuming a gaming value. The progressive bonus game is executed when a jackpot value reaches a predetermined progressive value. While the slot machine 10 is of a stand-alone type, which is not connected to a network, the present invention is also applicable to a networked slot machine.

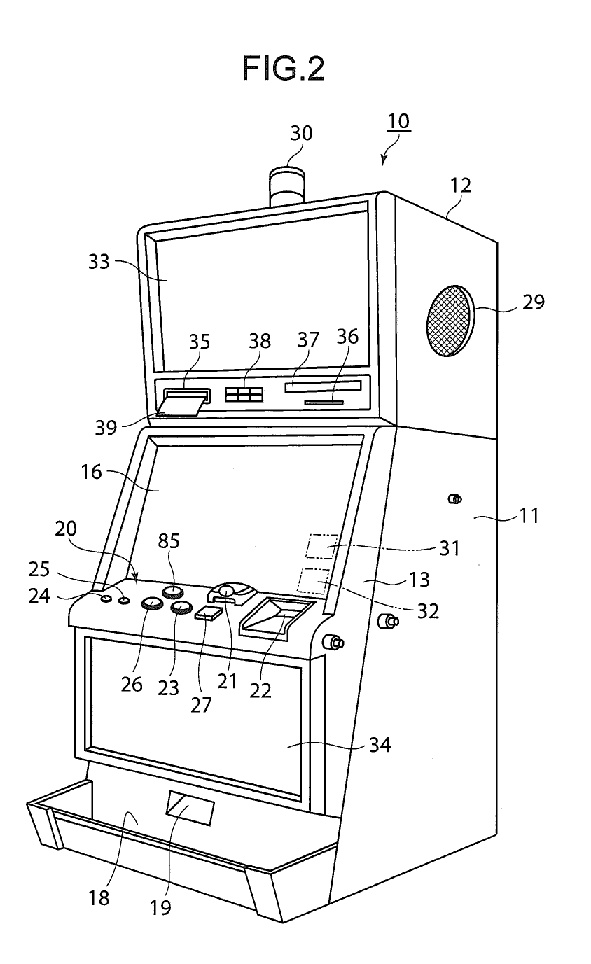

As shown in FIGS. 1A and 1B, a symbol matrix SM is displayed on a lower image display panel 16 (see FIG. 2) included in a slot machine 10 described later. A total of nine symbols in three rows and three columns are rearranged in the symbol matrix SM.

In the first embodiment of the present invention, any of symbols “main character 121”, “sub character 122”, “office building 123”, “gold bullion 124”, “car 125”, “stock certificate 126”, “jet 127”, and “villa 128”, are rearranged in the symbol matrix SM, and a payout is determined based on the number of respective symbols rearranged in the symbol matrix SM. In the case of a rearranged symbol in symbol matrix SM is a predetermined combination or a combination of numbers on a winning line on a symbol matrix SM coincides with the combination of input numbers a payment is determined.

As FIG. 1 shows, symbols “main character 121”, “sub character 122”, “office building 123”, “gold bullion 124”, “car 125”, “stock certificate 126”, “jet 127”, “villa 128”, and “stack of bills 129” with a plurality of numbers assigned are rearranged in the symbol matrix SM. In the case where rearranged symbols in symbol matrix SM form a predetermined combination or a combination of numbers on a winning line on a symbol matrix SM coincides with the combination of input numbers, a payment is paid out.

Furthermore, on input display region 70, that displays a combination of the input numbers, a selection display image 71 is displayed, and any of the symbols “main character 121, “sub character 122”, “office building 123”, “gold bullion 124”, “car 125”, “stock certificate 126”, “jet 127”, “villa 128”, and “stack of bills 129” with the input numbers assigned are rearranged. Here, because a combination of numbers (3), (7), and (2) are input via touch panel 69, selection display image 71 is displayed to show the word “Selection” was input during an input display region 70 displays “office building 123”, “jet 127”, “sub character 122” with numbers (3),(7), and (2) assigned. In the case of a combination of numbers assigned to a rearranged symbol on symbol matrix SM on a winning line input display region 70 coincides with the combination “office building 123”, “jet 127”, and “sub character 122” displayed on input display region 70 a payment is paid out.

FIG. 2 is a view schematically depicting a frame format of an appearance of the slot machine according to the first embodiment. The gaming media used in the slot machine 10 include coins, bills, or electronic value information equivalent thereto. In the present invention, however, medals, tokens, electronic money, or tickets, for example, may be employed as gaming mediums without being limitative thereto in particular. The above tickets are not limitative in particular, and can include barcode-attached tickets or the like, as described later, for example.

The slot machine 10 is provided with a cabinet 11, a top box 12 installed on an upper side of the cabinet 11, and a main door 13 provided on a front surface of the cabinet 11.

The lower image display panel 16 serving as a display device is provided in front of the main door 13. The lower image display panel 16 is provided with a liquid crystal panel, which displays the fifteen cells of the symbol matrix SM in three rows and five columns. In each symbol matrix SM, one symbol is arranged.

A credit amount display unit 31 of the lower image display panel 16 displays the number of coins credited by way of an image. A payout amount display unit 32 displays by way of an image the number of, for example, coins to be paid if a predetermined number or more symbols of respective types are rearranged in the elements of the symbol matrix SM.

Downwardly of the lower image display panel 16, a control panel 20 consisting of a plurality of buttons 23 to 27 for entering instructions pertinent to the progress of a game by a player; a coin insertion slot 21 for accepting coins in the cabinet 11; and a bill validator 22 are provided.

On the control panel 20, a start button 23, a change button 24, a cashout button 25, a 1-BET button 26, a MAX-BET button 27, and a side-BET button 85 are provided. The start button 23 is intended for entering a command for starting the game. The change button 24 is intended for use in asking an attendant of the gaming facility for change. The cashout button 25 is intended for entering a command for paying the credited coins to a coin tray 18 through a coin payout exit 19. The side-BET button 85 is intended for entering a command for betting coins on the game if players desire to place a bet on one more game.

The 1-BET button 26 is intended for entering a command for betting one coin among the credited coins on the game. The max-BET button 27 is intended for entering a command for betting the upper number (50 in this embodiment) of coins that can be bet per game among the credited coins on the game.

The bill validator 22 validates whether or not a bill is legitimate and accepts a legitimate bill into the cabinet 11. The bill validator 22 may be configured so that a barcode-attached ticket 39 described later is readable thereby. Provided on a lower front surface of the main door 13, that is, at a lower part of the control panel 20, is a berry glass 34 on which characters of the slot machine 10 and the like are depicted.

On the front face of the top box 12, an upper image display panel 33 is provided. The upper image display panel 33 has a liquid crystal panel, which displays images for introducing the game contents or explaining game rules, for example.

Also, on the top box 12, a speaker 29 and a lamp 30 are provided. At the lower side of the upper image display panel 33, a ticket printer 35, a card reader 36, a data display 37, and a keypad 38 are provided. The ticket printer 35 prints, on tickets, bar codes containing coded data such as credit amount, date and time, or ID numbers of the slot machine 10, and the bar code-attached tickets 39 are output. A player causes another slot machine to read the bar-code-attached tickets 39, allowing the slot machine to perform games, or alternatively, allowing the exchange of bar-code-attached tickets 39 with bills or the like at a predetermined site of a game facility (for example, at the casher in a casino).

The card reader 36 reads data from and write data into a smart card. The smart card is to be owned by the player, which stores data for identifying the player or data regarding the log of games executed by the player, for example. The smart card may store data equivalent to coins, bills, or credits. As an alternative of a smart card, a magnetic stripe card may be employed. The data display 37 is made up of a fluorescent display or the like, and stores data read by the card reader 36 or data input by a player via the keypad 38, for example. The keypad 38 is intended for entering the instructions or data pertinent to the issuance of tickets.

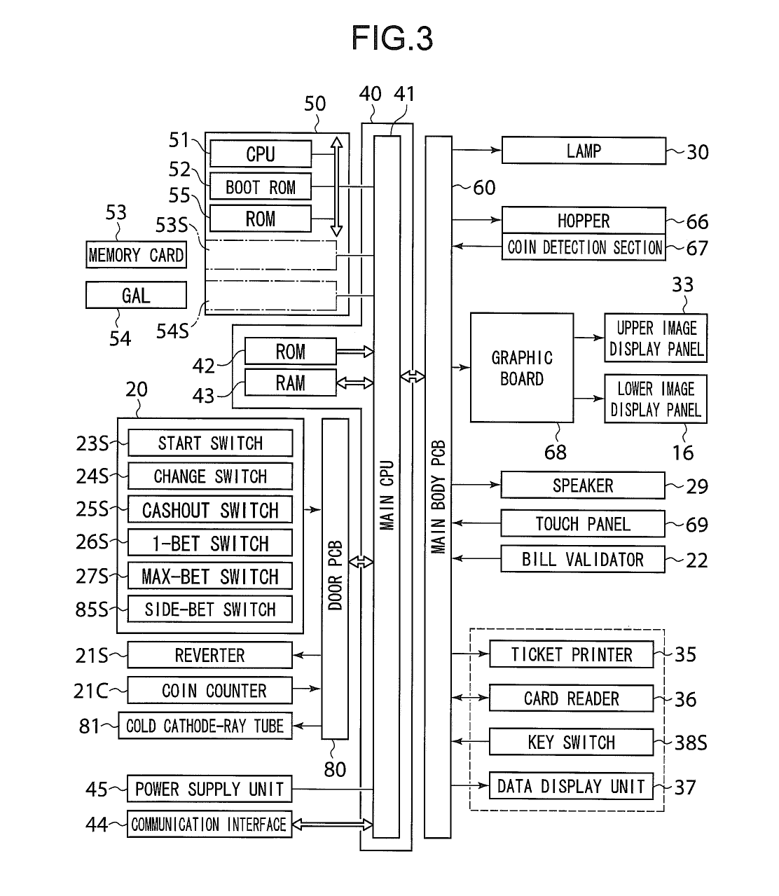

FIG. 3 is a block diagram depicting the internal construction of the slot machine shown in FIG. 2. A gaming board 50 includes: a CPU (Central Processing Unit) 51, a ROM (Read-only Memory) 55 and a boot ROM 52 interconnected by an internal bus; a card slot 53S corresponding to a memory card 53; and an IC socket 54S corresponding to a GAL (Generic Array Logic) 54.

A memory card 53 is composed of a non-volatile memory, such as CompactFlash (registered trademark), and stores a game program. The game programs include a symbol selection program. The aforementioned symbol selection program is intended for determining the symbols to be rearranged in the elements of the symbol matrix SM. The symbol selection program includes symbol weighing data corresponding to each of a plurality of kinds of payout ratios (for example, 80%, 84%, and 88%). The symbol weighting data is indicative of the correspondence relationship between the respective symbols and one or more random numeric values which come under a predetermined numerical range (0 to 255). The payout ratio is determined according to the payout-ratio setting data output from the GAL 54. The symbols to be rearranged in the elements of the symbol matrix SM are determined depending upon the symbol weighing data corresponding to the payout ratio. Further, the game programs include table data indicating the correspondence relationship between each of the symbols and a payout.

Also, the card slot 53S is configured to allow the memory card 53 to be inserted thereinto or ejected therefrom, and is connected to a mother board 40 through an IDE pass. Accordingly, the memory card 53 can be ejected from the card slot 53S, other game programs and other game system programs can then be written into the memory card 53, and further, the memory card 53 can be inserted into the card slot 53S, thereby allowing the player to change the types and contents of games executed in the slot machine 10. The game program includes programs concerning a game progress. The game programs include those which are relevant to the operating procedures for performing games. Furthermore, the game program includes image data or sound data to be output during the game. The image data include, for example, image data indicative of the symbol matrix.

The GAL 54 is a kind of PLD having an OR-fixed arrayed structure. The GAL 54 is provided with pluralities of IN ports and OUT ports. If predetermined items of data are input to the IN port, the corresponding data is output from the OUT port. The data output from the OUT port is equivalent to the above-described payout rate setting data. In addition, an IC socket 54S is constituted to enable removable insertion of GAL 54, and the card slot is connected to a motherboard 40 by means of a PCI bus. Therefore, GAL is replaced with the replacement GAL 54, thereby making it possible to vary the payout rate setting data.

The CPU 51, the ROM 55, and the boot ROM 52 interconnected by the internal bus are connected to the motherboard 40 by the PCI bus. The PCI bus serves to transmit signals between the mother board 40 and the gaming board 50 and supply power from the mother board 40 to the gaming board 50.

The motherboard 40 is constructed using a general-purpose motherboard commercially available (a printed circuit board on which essential parts of a personal computer are mounted) and includes: a main CPU 41, a ROM (Read Only Memory) 42; a RAM (Random Access Memory) 43; and a communication interface 44. The main CPU 41 functions as a processor for controlling a display device and memory according to the embodiment of the present invention.

The ROM 42 stores the programs and permanent data of a BIOS (Basic Input/Output System) or the like, which is made up of memory devices such as a flash memory and executed by the main CPU 41. When the BIOS is executed by the main CPU 41, processing of initializing predetermined peripheral devices is carried out and processing of capturing game programs and game system programs stored in the memory card 53 through the gaming board 50 is started. In the present invention, the contents of the ROM 42 may be rewritable or not.

The RAM 43 stores data and programs used when the main CPU 41 is activated. The RAM 43 can also store game programs. Further, the RAM 43 stores the data of credit amounts and coin insertion numbers or payout numbers in one game.

To the motherboard 40, a main body PCB (Printed Circuit Board) 60 and a door PCB 80, described later, is interconnected by means of a USB. A power supply unit 45 is also connected to the motherboard 40.

To the main body 60 and the door PCB 80, equipment or devices, for generating an input signal input to the main CPU 41, and those of which operation is controlled by means of a control signal output from the main CPU 41, are connected. The main CPU 41 executes the game programs stored in RAM 43, based upon an input signal that was input to the main CPU 41, thereby performing predetermined computational processing. Then, this CPU 41 stores results thereof into RAM 43; and transmits control signals to equipment and devices as control processing relative to the equipment and devices.

Connected to the main body PCB 60 are a lamp 30, a hopper 66, a coin detecting section 67, a graphic board 68, a speaker 29, a touch panel 69, a bill validator 22, a ticket printer 35, a card reader 36, a key switch 38S, and a data display 37. The lamp 30 illuminates in a predetermined pattern, based on a control signal output from a main CPU 41. The lamp 30 lights in a predetermined pattern, based upon a control signal output from the main CPU 41.

The hopper 66 is installed in a cabinet 11, and a predetermined number of coins are paid out from the coin payout opening 19 to the coin tray 18, based upon the control signal output from the main CPU 41. A coin detecting section 67 is provided inside of the coin payout opening 19, and outputs an input signal to the main CPU 41, if it is detected that a predetermined number of coins have been paid out from the coin payout opening 19.

A graphic board 68 controls the images to be displayed on the upper and lower image display panels 33 and 16, based upon the control signal output from the main CPU 41. The credit amount display region 31 (see FIG. 2) on the lower image display panel 16 displays the number of credits stored in the RAM 43. Further, the payout amount display region 31 (see FIG. 2) on the lower image display panel 16 displays the number of coins to be paid out. The graphic board 68 is provided with: a VDP (Video Display Processor), which generates image data, based upon the control signal output from the main CPU 41; and a video RAM, etc., which temporarily stores image data generated by the VDP. The image data used when the image data is generated by the VDP is read from the memory card 53, and thereafter, is included in the game programs stored in the RAM 43.

The bill validator 22 validates whether or not a bill is legitimate and accepts a legitimate bill into the cabinet 11. The bill validator 22, upon accepting a legitimate bill, outputs an input signal to the main CPU 41 based on the bill amount. The main CPU 41 stores in the RAM 43 the amount of credits responsive to the amount of bills transmitted by the input signal.

Based on a control signal output from the main CPU 41, the ticket printer 35 prints on a ticket a barcode having encoded thereon data such as the credit amount, data and time, and the identification number of the slot machine 10 stored in the RAM 43. Further, this printer outputs the printed ticket as a barcode-attached ticket 39. The card reader 36 reads data from a smart card, thereby transmitting the read data to the main CPU 41 or writing data into the smart card, based upon the control signal from the main CPU 41. The key switch 38S is provided on the key pad 38, and outputs a predetermined input signal to the main CPU 41 when a player operates the key pad 38. The data display 37 displays, based upon a control signal output from the main CPU 41, the data read by the card reader 36 and the data input by a player through the key pad 38.

To the door PCB 80, a control panel 20, a reverter 21S, a coin counter 21C, and a cold cathode-ray tube 81 are connected. The control panel 20 is provided with: a start switch 23S corresponding to the start button 23; a change switch 24S corresponding to the change button 24; a cashout switch 25S corresponding to a cashout button 25; a 1-BET switch 26S corresponding to a 1-BET button 26; a MAX-BET switch 27S corresponding to the MAX-BET button 27; and a side-BET switch 85S corresponding to the side-BET switch 85. When the player operates the buttons 23 to 27, and 85 the corresponding switches 23S to 27S and 85S output input signals to the main CPU 41, respectively.

The coin counter 21C is provided inside the coin receiving slot 21, and validates whether or not a legitimate coin is inserted into the coin receiving slot 21. Those other than the legitimate coins are discharged from the coin payout exit 19. The coin counter 21C outputs an input signal to the main CPU 41 when a legitimate coin is detected. This coin counter discriminates whether a coin inserted by a player into the coin receiving slot 19 is valid or invalid. Those other than the valid coins are discharged from the coin payout exit 19. The coin counter 21C also outputs an input signal to the main CPU 41 if a valid coin is detected.

The reverter 21S is operable based upon the control signal output from the main CPU 41. This reverter distributes, the coins recognized to be legitimate by the coin counter 21C, into a cashbox (not shown) or a hopper 66 which was installed in the slot machine 10. In other words, if the hopper 66 is filled with coins, the legitimate coins are distributed to the cashbox by means of the reverter 21S. Otherwise, the legitimate coins are distributed to the hopper 66. The cold cathode-ray tube 81 functions as a backlight installed at the rear side of the lower and upper image display panels 16 and 33, and lights based upon the control signal that was output from the main CPU 41.

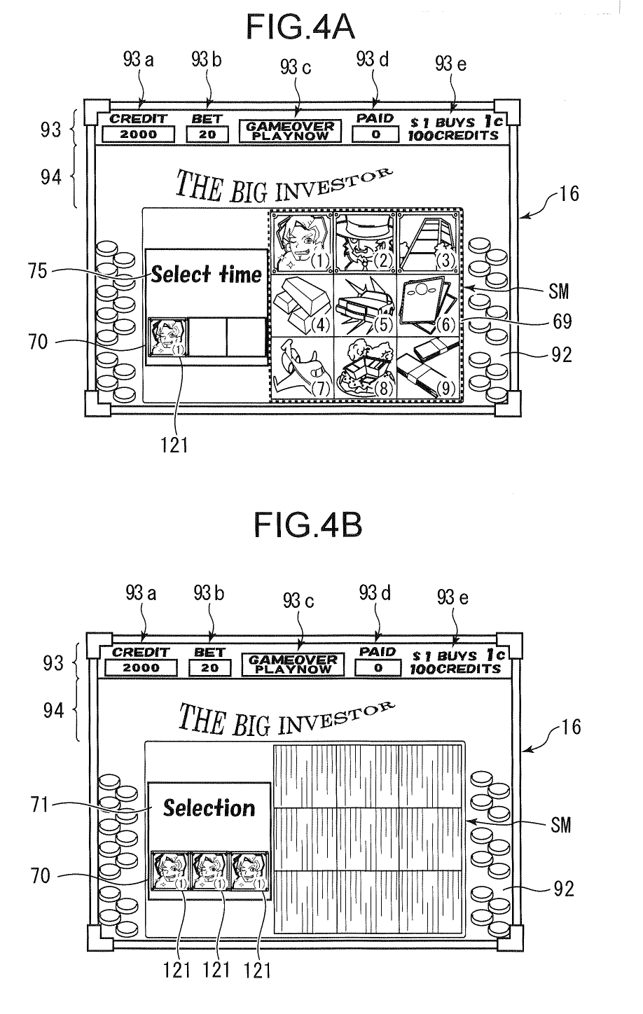

FIG. 4 to FIG. 9. are views showing one example of an image displayed in the slot machine shown in FIG. 2 according to the first embodiment. FIGS. 4A and 4B are views each showing an exemplary symbol matrix displayed during the basic game in the slot machine shown in FIG. 2.

As shown in FIG. 4A, the lower image display panel 16 is made up of a display region 92, an information display region 93, an effect image display region 94, and the like. The display area section 92 is for displaying a symbol matrix SM. In addition, the information display region 93 is arranged above the display area section 92. This display region is made up of a credit amount display region 93a, a BET amount display region 93b, a character information display portion 93c, a PAID amount display region 93d, and a charge display region 93e.

The number of coins presently credited is displayed at the credit amount display region 93a while the number of coins bet in one game is displayed at the BET amount display region 93b. The character information indicative of a current status of the game is displayed at the character information display region 93c. The characters of “PLAYNOW” are displayed during the play of the game, whereas the characters of “GAMEOVER” are displayed during the intervals between the plays of the game. The number of coins that has been successfully obtained in one game is displayed at the PAID amount display region 93d, whereas a conversion value of the credit amount based on a predetermined charge is displayed at the charge display region.

At the effect image display region 94, effect images in accordance with a type of the present slot game are displayed. In other words, the effect image display region 94 displays different effect images between the basic and free games.

From among the symbols, “main character 121”, “sub character 122”, “office building 123”, “gold bullion 124”, “car 125”, “stock certificate 126”, “jet 127”, and “villa 128”, and “stack of bills 129” are rearranged in the symbol matrix SM displayed on the lower image display panel 16. In the case of a rearranged symbol in symbol matrix SM is a predetermined combination or a combination of numbers on a winning line on a symbol matrix SM coincides with the combination of input numbers a payment is paid out.

Here, symbols “main character 121”, “sub character 122”, “office building 123”, “gold bullion 124”, “car 125”, “stock certificate 126”, “jet 127”, “villa 128”, and “stack of bills 129” with corresponding plurality of numbers are rearranged. Furthermore, on any of rearranged symbols “main character 121”, “sub character 122”, “office building 123”, “gold bullion 124”, “car 125”, “jet 127”, “villa 128”, and “stack of bills 129” will be rearranged on input display region 70 displaying combinations of input numbers. Here, number (1) is input via a touch panel 69, therefore an image 71 that reads “select time” is displayed and on a display region 70 a symbol “main character 121” with number (1) assigned is displayed.

As FIG. 4B shows, when the start button is manipulated, symbols are displayed in a scrolling manner on each symbol matrix SM. Further, any of symbols “main character 121”, “sub character 122”, “office building 123”, “gold bullion 124”, “car 125”, “stock certificate 126”, “jet 127”, “villa 128”, and “stack of bills 129” on an input display device 70 assigned with input numbers are rearranged. Here, because a combination of numbers (1)(1)(1) was input via a touch panel 69, selection display image 71 is displayed to indicate that the word “Selection” was input.

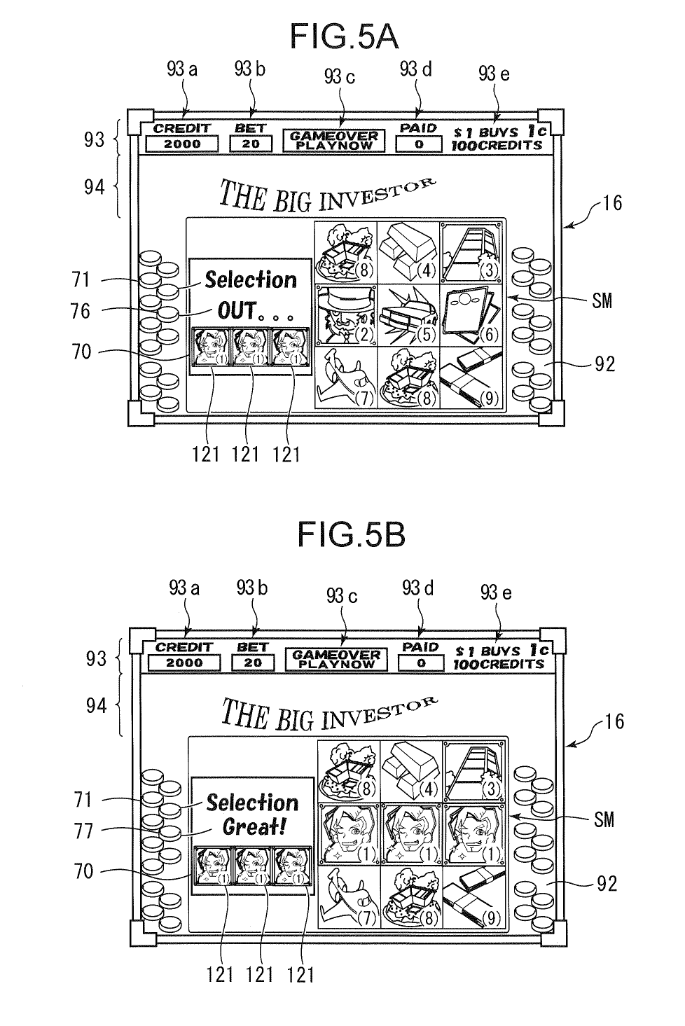

FIG. 5A is a diagram illustrating an exemplary image displayed in the slot machine 10 shown in FIG. 2. FIG. 5B is a diagram illustrating an exemplary symbol matrix, according to the first embodiment. Symbols from among the symbols, “main character 121”, “sub character 122”, “office building 123”, “gold bullion 124”, “car 125”, “stock certificate 126”, “jet 127”, “villa 128”, and “stack of bills 129” are rearranged in the symbol matrix SM as shown on FIG. 5. On a center line of a symbol matrix SM, one basic line BL is set. In the embodiments of the present invention, the basic line shall mean a winning line.

Furthermore, symbols from among the symbols, “main character 121”, “sub character 122”, “office building 123”, “gold bullion 124”, “stock certificate 126”, “jet 127”, “villa 128”, and “stack of bills 129” with input numbers assigned are rearranged on a combination of input numbers displayed on a input display region 70. Here, because (1)(1)(1) was input via a touch panel 69, a combination of 3 symbols “main character 121” is displayed.

Here, because a combination of symbols “sub character 122”, “car 125”, “stock certificate 126” was rearranged, a predetermined combination information display 76a called “out” is displayed, then a rearranged symbol on a winning line on a symbol matrix SM rearranged symbol is input via a touch panel 69 a displayed “main character 121” does not match the three combination thus a payout is not given.

From among the symbols with plural numbers assigned, “main character 121”, “sub character 122”, “office building 123”, “gold bullion 124”, “car 125”, “stock certificate 126”, “jet 127”, “villa 128”, and “stack of bills 129” are rearranged in the symbol matrix SM displayed as shown on FIG. 5B. On a center line of a symbol matrix SM, one basic line BL is set.

Furthermore, a input display region 70 which displays a combination of input numbers, symbols from among symbols with assigned numbers “main character 121”, “sub character 122”, “office building 123”, “gold bullion 124”, “car 125”, “stock certificate 126”, “jet 127”, “villa 128”, and “stack of bills 129” are rearranged. Here, because a combination of numbers (1)(1)(1) was input via a touch panel 69, a combination of three symbols “main character 121” is displayed.

Here, because a combination of 3 symbols “main character 121” were rearranged on the winning line a combination information display 76b displays the word “Great”. Then a combination of numbers assigned to a symbol on a winning line of a symbol matrix SM is input via a touch panel 69. Then a combination of three “main character 121” displayed on an input display region 70 is a combination which triggers a free game thus a free game is initiated.

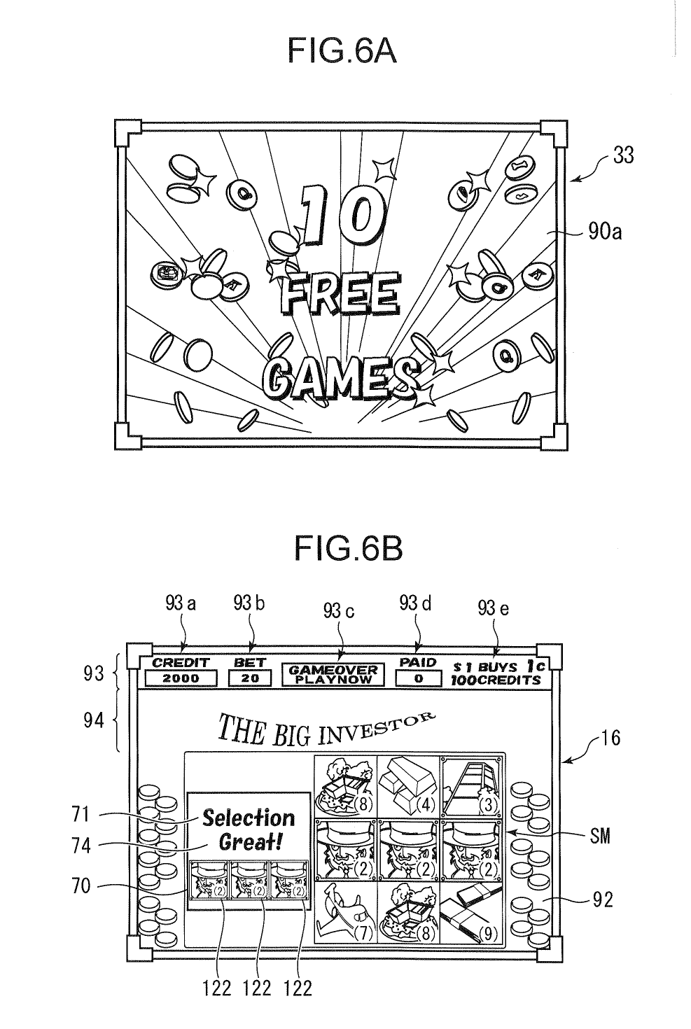

FIG. 6A is a diagram illustrating an exemplary image displayed in the slot machine 10 shown in FIG. 2. FIG. 6B is a diagram illustrating an exemplary symbol matrix, during the free game according to the first embodiment. As shown in FIG. 6A, when the symbols rearranged in the elements of the symbol matrix SM in FIG. 5A are rearranged to form a combination for executing the free game, i.e., the combination of the three symbols “main character 121”, the free game is started. Upon starting the free game, the upper image display panel 33 displays a free-game-number display image 90a indicative of the number of times in executing the free game. In this case, the free-game-number display image 90a of “10 FREE GAME” is displayed indicating that the number of times in executing the free game has been set to ten.

As shown in FIG. 6B, in the symbol matrix SM, the symbols, “main character 121”, “sub character 122”, “office building 123”, “gold bullion 124”, “car 125”, “stock certificate 126”, “jet 127”, “villa 128”, and “stack of bills 129” are rearranged in any of the elements of the symbol matrix SM.

Further, from among the symbols with input numbers assigned, “main character 121”, “sub character 122”, “office building 123”, “gold bullion 124”, “car 125”, “stock certificate 126”, “jet 127”, “villa 128”, and “stack of bills 129” is rearranged on the input display region 70 which displays the input combination. Here, because a combination of numbers (2)(2)(2) was input via a touch panel 69, a combination of 3 identical symbols “sub character 122” is displayed.

Here, a combination of three identical symbols “main character 121” has been rearranged, and thus, a combination information display 76b that reads “Great” is displayed. Then a combination of numbers assigned to a symbol on a winning line of a symbol matrix SM was input via a touch panel 69. Moreover, a “sub character 122” displayed on input display region 70 corresponds to the three combination a payout is paid and because “sub character 122” and the 3 combinations triggers a jackpot bonus game a jackpot bonus game is initiated.

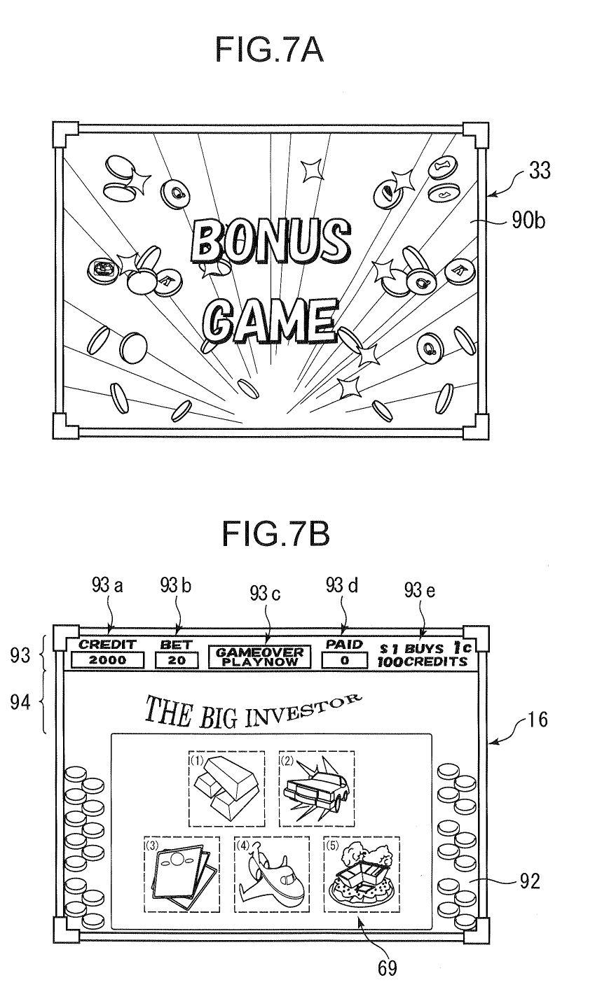

FIGS. 7A and 7B are diagrams each illustrating an exemplary image displayed in the slot machine 10 according to the first embodiment, shown in FIG. 2, during the jackpot bonus game. As shown in FIG. 7A, when the symbols rearranged in the elements of the symbol matrix SM in FIG. 6B are rearranged to match a combination for executing the jackpot bonus game, i.e., the combination of the three “sub character 122”, the jackpot bonus game is started. When start of the jackpot bonus game is determined, the upper image display panel 33 displays a jackpot-bonus-game display image 90b indicative of start of the jackpot bonus game. In this case, the jackpot-bonus-game display image 90b of “BONUS GAME” is displayed indicating that the jackpot bonus game is to be started.

As shown in FIG. 7B, upon starting the jackpot bonus game, the display region 92 displays a selection screen for determining types of jackpot bonus games. In this case, the symbols (1) to (5) including “gold bullion 124”, “car 125”, “stock certificate 126”, “jet 127”, and “villa 128” are displayed so that a type of the jackpot bonus game can be selected by selecting one from among these symbols though a touch panel 69.

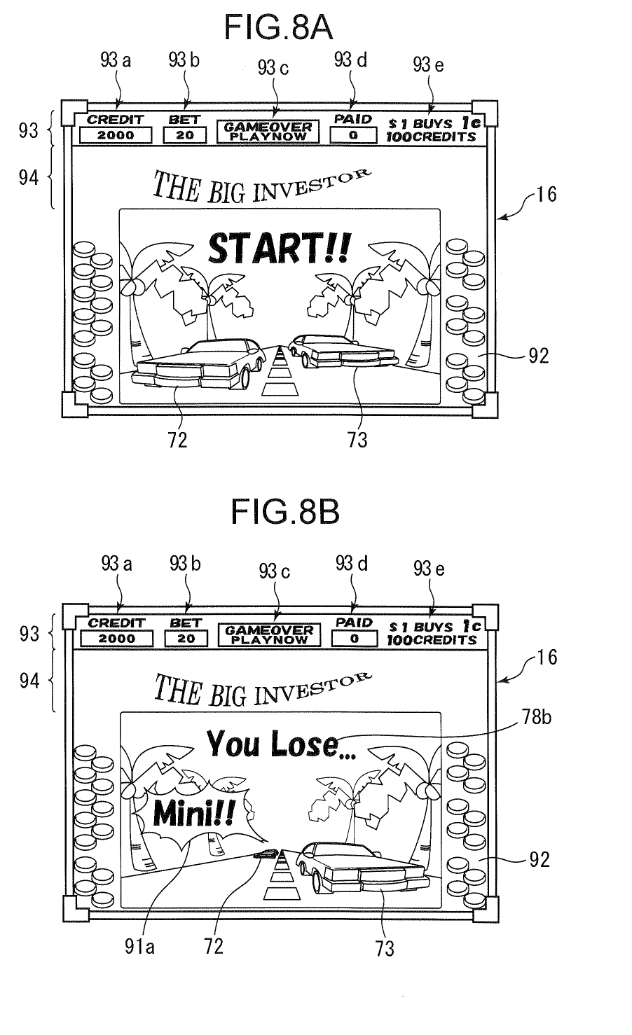

FIGS. 8A and 8B are diagrams each illustrating an exemplary image displayed in the slot machine 10 according to the first embodiment shown in FIG. 2, during the jackpot bonus game. As shown in FIG. 7A, the jackpot bonus game is displayed which corresponds to the symbol selected in FIG. 6B. When the symbol (2) is selected in FIG. 6B, the jackpot bonus game of a car race is started. After that, a car-race start screen is displayed which constitutes the main character effect image 72 and the sub character effect image 73.

As shown in FIG. 8B, displayed next is a win-or-lose screen of the jackpot bonus game that corresponds to the symbol selected in FIG. 7B. In this case, when the symbol (2) is selected in FIG. 7B and the main character effect image 72 wins in the jackpot bonus game of the car race, a win-or-lose information display 75a of “You Win” is displayed.

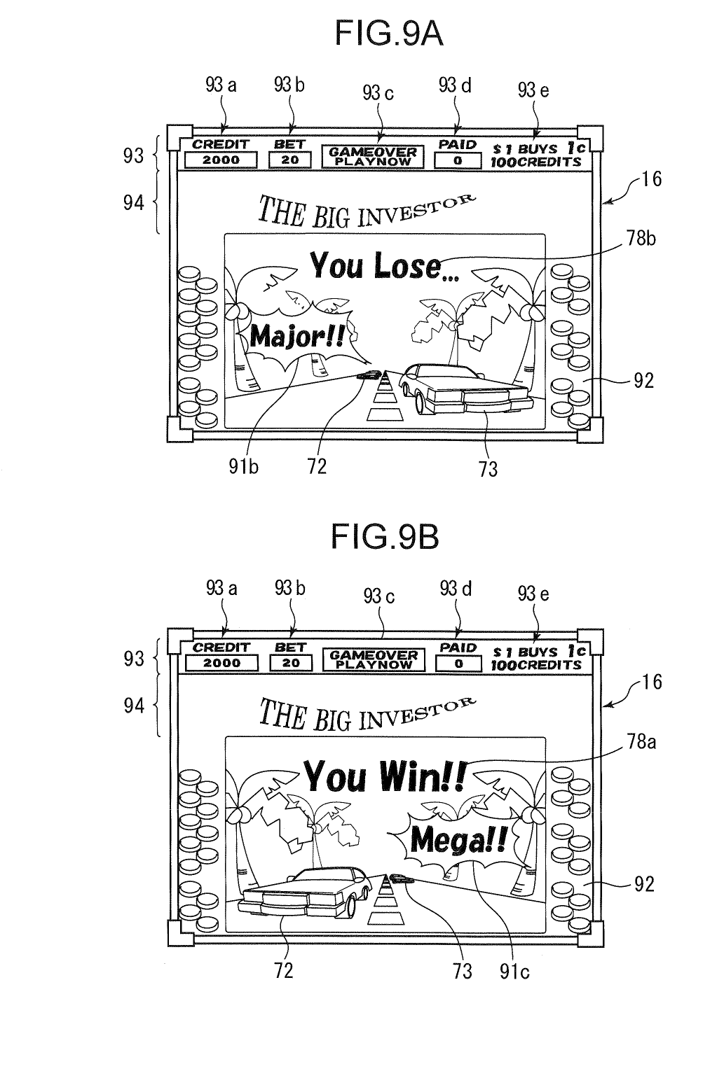

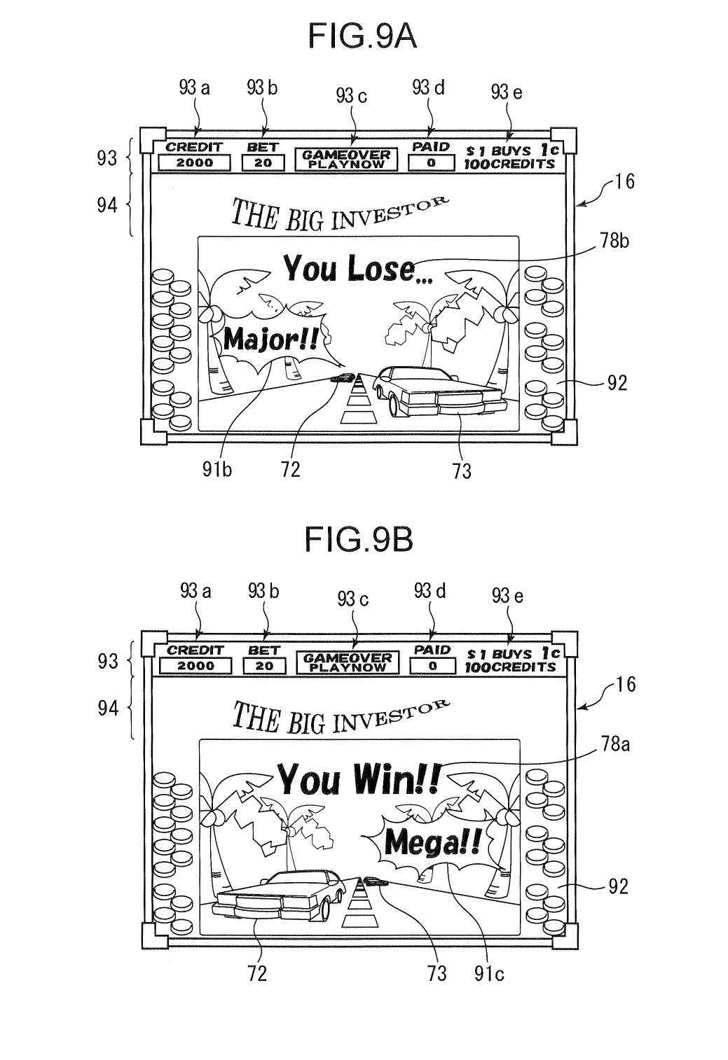

FIGS. 9A and 9B are diagrams each illustrating an exemplary image displayed in the slot machine 10 according to the first embodiment shown in FIG. 2, during the jackpot bonus game. As shown in FIG. 9A, a win-or-lose screen of the jackpot bonus game is displayed which corresponds to the symbol selected in FIG. 7B. When the symbol (2) is selected in FIG. 7B and the sub character effect image 73 wins in the jackpot bonus game of a car race, a win-or-lose information display 78b of “You Lose” is displayed. A payout display image 74 of “Mini” is displayed which is indicative of types of payouts of the jackpot, and then, the payout corresponding to “Mini” is awarded.

As shown in FIG. 9B, the display region 92 displays a selection screen of the jackpot bonus game corresponding to the symbol selected in FIG. 7B. When the symbol (2) is selected in FIG. 7B and the “main character 121” wins in the jackpot bonus game of a car race (see FIG. 8B), the display region 92 displays a selection screen for determining the types of a subsequent jackpot bonus game and identifiably displays the fact that the symbol (2) is selected last time in FIG. 7B. Selecting any symbol other than (2) from a touch panel 69 executes a subsequent jackpot bonus game.

Next, a process executed in the slot machine 10 according to the first embodiment will be described in detail with reference to the accompanying drawings. The main CPU 41 reads out and executes a game program, thereby conducting the game.

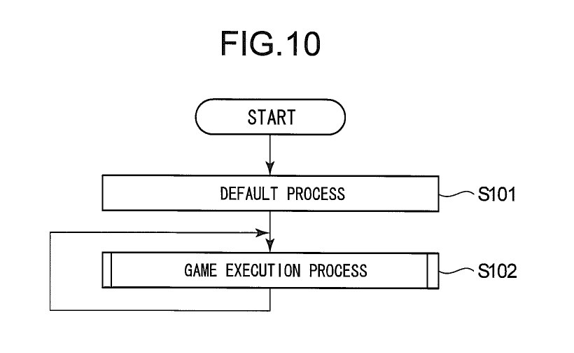

FIG. 10 is a flowchart showing a subroutine of main process according to the first embodiment. In the main process, first, when a power switch is turned on (that is, when power is supplied), a motherboard 40 and a gaming board 50 are activated respectively, so that the CPU 51 executes an initial setting process (step S101). In this initial setting process, the main CPU 41 executes the BIOS stored in the ROM 42, decompresses, in the RAM 43, compressed data included in the BIOS, executes the BIOS decompressed in the RAM 43, and performs diagnosis and initialization of each of the peripheral devices. Further, the main CPU 41 writes game programs or the like from the ROM 42 into the RAM 43, and acquires payout-ratio setting data and country-identification information. The main CPU 41 also performs an authentication process for each program during execution of the initial setting process.

Next, the main CPU 41 performs a game execution process described later with reference to FIG. 10 (step S102). In this game execution process, the main CPU 41 sequentially reads and executes the game programs or the like from the ROM 42. By performing this game execution process, the slot machine 10 executes the game according to the first embodiment. The game execution process is repeatedly performed while power is supplied to the slot machine 10.

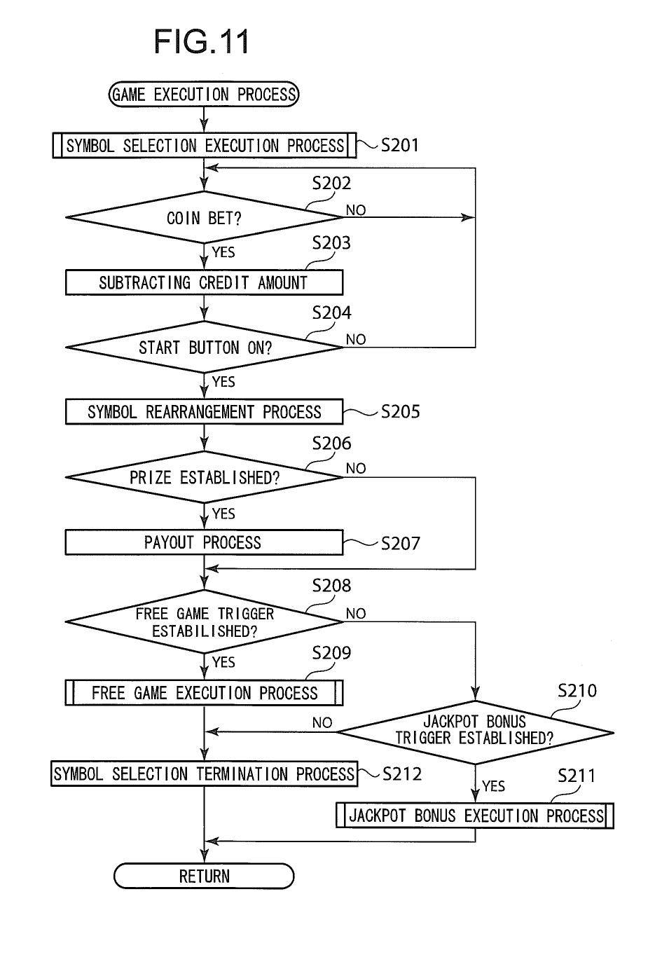

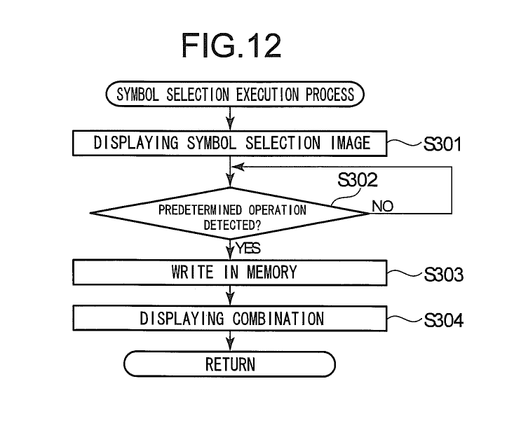

FIG. 11 is a flowchart showing a subroutine of the game execution process invoked and performed at step S102 of the subroutine shown in FIG. 10 according to the first embodiment. First, the main CPU 41 performs a symbol selection program described later with reference to FIG. 12 (step S201). Specifically, in order for the main CPU 41 to display symbols, with plural types of numbers assigned, for entering a combination of numbers, a combination of numbers from among the displayed symbols must be displayed.

Next, the main CPU 41 judges whether a coin has been bet or not (step S202). Specifically, the main CPU 41 judges whether or not an input signal has been received, the signal being output from the 1-BET switch 26S when the 1-BET button 26 is pressed, or alternatively, being output from the MAX-BET switch 27S when the MAX-BET button 27 is pressed. The main CPU 41 controls the current step to return to the process at the step S202 upon judging that no coin has been bet (step S202: NO).

On the other hand, the main CPU 41 subtracts the number of bet coins from the credit amount stored in the RAM 43 (step S203) upon judging that a coin has been bet (step S202: YES). In the case where the number of bet coins is greater than the credit amount stored in the RAM 43, the main CPU 41 controls the current step to return to step S101 without performing the process for subtracting the number of bet coins from the credit amount stored in the RAM 43. In the case where the number of bet coins exceeds the upper limit (fifty coins in this embodiment) of coins that can be bet in one game, the main CPU 41 controls the process to shift to step S204 without performing the process for subtracting the number of bet coins from the credit amount stored in the RAM 43.

The main CPU 41 then judges whether or not the start button 23 has been set to ON (step S204). Specifically, the main CPU 41 judges whether or not an input signal has been received, the signal being output from the start switch 23S when the start button 23 is pushed. The main CPU 41 controls the step to return to step 202 upon judging that the start button 23 has not been set to ON (step S204: NO). Where the start button 23 has not been set to ON (for example, where an instruction has been input to terminate the game without setting the start button 23 to ON), the main CPU 41 cancels acceptance of a subtraction result at step S202.

On the other hand, upon judging that the start button 23 has been set to ON (step S204: YES), the main CPU 41 performs the symbol rearrangement process (step S205). Specifically, the CPU 41 executes the program stored in the RAM 43 and determines the symbols to be rearranged in the symbol matrix SM displayed on the lower image display panel 16. The symbols are determined from among the symbols, “main character 121”, “sub character 122”, “office building 123”, “gold bullion 124”, “car 125”, “stock certificate 126”, “jet 127”, “villa 128”, and “stack of bills 129”. This determination is based on the symbol weighting data and random numeric values sampled by sampling the random numeric values in a numerical range which comes under a predetermined range of random numeric values. The CPU 41 then rearranges the symbols in the symbol matrix SM.

Next, the main CPU 41 judges whether or not a prize has been established (step S206). Specifically, the main CPU 41 judges whether or not a predetermined combination of symbols having been rearranged in the symbol matrix SM or numbers assigned to a rearranged symbol on a winning line corresponds to the input numbers. Here, the prize is established on condition that a predetermined number of symbols of the same type are rearranged in the symbol matrix SM and also on condition a combination of numbers assigned to symbols corresponds to a combination stored in RAM 42.

Upon judging that the prize is established (step S206: YES), the main CPU 41 then executes a coin-payout process in accordance with the amount of bet and the number of coins set for the winning number (step S207). Where the coins are deposited, main CPU 41 performs a process of adding the number of credits stored in RAM 43. On the other hand, in the coin-payout process, the main CPU 41 transmits the control signal to the hopper 66 to pay out the predetermined amount of coins.

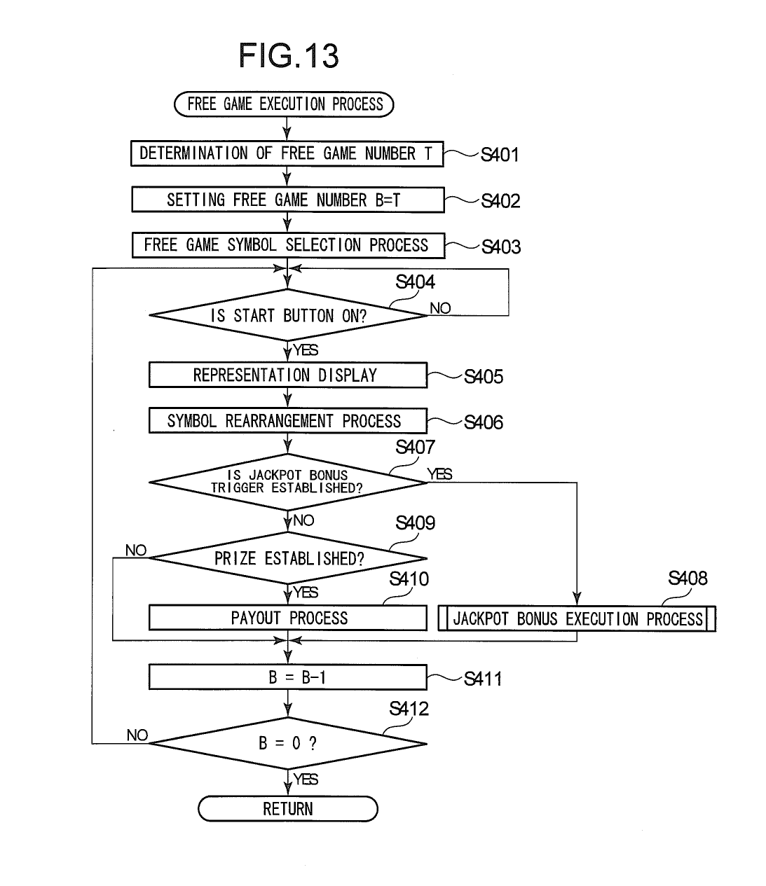

On the other hand, when judging that the prize is not established (step S206: NO) or executing the process at step S207, the main CPU 41 judges whether or not a free game trigger has been established (step S208). Specifically, the main CPU 41 executes the program stored in the RAM 43 to sample the random numeric values in a numerical range which comes under a predetermined range of random numeric values, thereby judging whether or not the free game trigger condition has been satisfied based on the sampled random numeric values. Upon judging that the free game trigger is established (step S208: YES), the main CPU 41 performs a free-game execution process described later with reference to FIG. 13 (step S209). In this free-game execution process, the main CPU 41 sequentially reads and executes the game programs or the like from the ROM 42 and performs the free-game execution process. Upon terminating this process, the main CPU 41 controls the step to move to step S212.

On the other hand, upon judging that the free game trigger has not been established (step S208: NO), the main CPU 41 judges whether or not a jackpot bonus game trigger has been established (step S210). Specifically, the main CPU 41 executes the program stored in the RAM 43 to sample the random numeric values in a numerical range which comes under a predetermined range of random numeric values, thereby judging whether or not the jackpot bonus game trigger has been established based on the sampled random numeric values. Upon judging that the jackpot bonus game trigger is established (step S210: YES), the main CPU 41 executes a jackpot bonus game execution process described later with reference to FIG. 13 (step S211). In this jackpot bonus game, the main CPU 41 sequentially reads and executes the game programs or the like from the ROM 42 to execute the jackpot bonus game execution process.

The CPU 41 performs a symbol selection process (step S212) upon judging that the jackpot bonus game trigger has not been established (step S210: NO) or when the process of step 209 terminates. In this symbol selection termination process, the main CPU 41 terminates the display of a combination of input numbers displayed on input display region 70, thus clearing the numbers assigned to symbols “main character 121”, “sub character 122”, “office building 123”, “gold bullion 124”, “car 125”, “stock certificate 126”, “jet 127”, “villa 128”, and “stack of bills 129” stored in RAM 43.

FIG. 12 is a flowchart showing a subroutine of the symbol selection process invoked and performed at step S201 of the subroutine shown in FIG. 12 according to the first embodiment. First, the main CPU 41 displays a symbol selection image (step S301). Specifically, the main CPU 41 rearranges “main character 121”, “sub character 122”, “office building 123”, “gold bullion 124”, “car 125”, “stock certificate 126”, “jet 127”, “villa 128”, and “stack of bills 129”, for inputting numbers corresponding to the plural types of numbers assigned to symbols from the touch panel 69 in each of symbol matrixes SM (see FIG. 4A).

Next, the main CPU 41 judges whether or not the predetermined process has been detected (step S302). Specifically, the main CPU 41 via a touch panel 69 judges whether or not numbers assigned to symbols “main character 121”, “sub character 122”, “office building 123”, “gold bullion 124”, “car 125”, “stock certificate 126”, “jet 127”, “villa 128”, and “stack of bills 129” were input or not. Upon judging that a predetermined process was not detected (step S302: NO), the main CPU 41 controls the step to return to step S302.

On the other hand, upon judging that a predetermined process has been detected (step S302: YES), a combination of numbers are stored in the memory (S303). Specifically, the main CPU 41 stores numbers assigned to symbols “main character 121”, “sub character 122”, “office building 123”, “gold bullion 124”, “car 125”, “stock certificate 126”, “jet 127”, “villa 128”, and “stack of bills” in RAM 43.

Next, the main CPU 41 displays the combination (step S304). Specifically, the main CPU 41 combines memory stored during step S303 and displays them in input display region 70 (see FIG. 4B). The main CPU 41 terminates the symbol selection process when executing this process.

FIG. 13 is a flowchart showing a subroutine of the free game execution process invoked and executed at step S209 of the subroutine shown in FIG. 11 according to the first embodiment. First, the main CPU 41 determines a free-game number T as a number of times in executing the free game (step S401). Specifically, the main CPU 41 determines the free-game number T in accordance with a program stored in the RAM 43.

Next, the main CPU 41 performs a process for setting the free-game number B=K (step S402). Specifically, the main CPU 41 sets a remaining free-game number B=T in the storage area provided in the RAM 43, the area for storing the data indicative of the remaining free-game number B as the remaining number of times in executing the free game. A value of T is equal to the free-game number T determined at step S401.

Next, the main CPU 41 performs a free game symbol selection process for the free game (step S403). Specifically, the main CPU displays symbols with plural types of numbers assigned, for entering a combination of numbers, and then, displays a combination of numbers from the displayed symbols.

The main CPU 41 then judges whether or not the start button 23 has been set to ON (step S404). Specifically, the main CPU 41 judges whether or not an input signal has been received, the signal being output from the start switch 23S when the start button 23 is pushed. The main CPU 41 controls the step to return to step S404 upon judging that the start button 23 has not been set to ON (step S404: NO).

On the other hand, upon judging that the start button 23 has been set to ON (step S404: YES), on the other hand, the main CPU 41 performs a process for displaying an effect image (step S405). Specifically, the main CPU 41 displays a free-game-number display images 90a (see FIG. 6) corresponding to the free-game number on the upper image display panel 33.

Next, the main CPU 41 performs a symbol rearrangement process for the free game (step S406). Specifically, the main CPU 41 executes the program stored in the RAM 43 and determines the symbols to be rearranged in the symbol matrix SM displayed on the lower image display panel. These symbols are selected from among the symbols “main character 121”, “sub character 122”, “office building 123”, “gold bullion 124”, “car 125”, “stock certificate 126”, “jet 127”, “villa 128”, and “stack of bills 129”. This determination is based on the symbol weighing data and random numeric values sampled by sampling the random numeric values in a numeric-value range which comes under a predetermined range of random numeric values. The main CPU 41 then rearranges the symbols to be rearranged in the symbol matrix SM.

Next, the main CPU 41 judges whether or not a jackpot bonus trigger has been established (step S407). Specifically, the main CPU 41 executes the program stored in the RAM 43 to sample the random numeric values in a numerical range which comes under a predetermined range of random numeric values, thereby judging whether or not the jackpot bonus game trigger has been established based on the sampled random numeric values. Upon judging that the jackpot bonus game trigger has been established (step S407: NO), the main CPU 41 controls the process to shift to step S409.

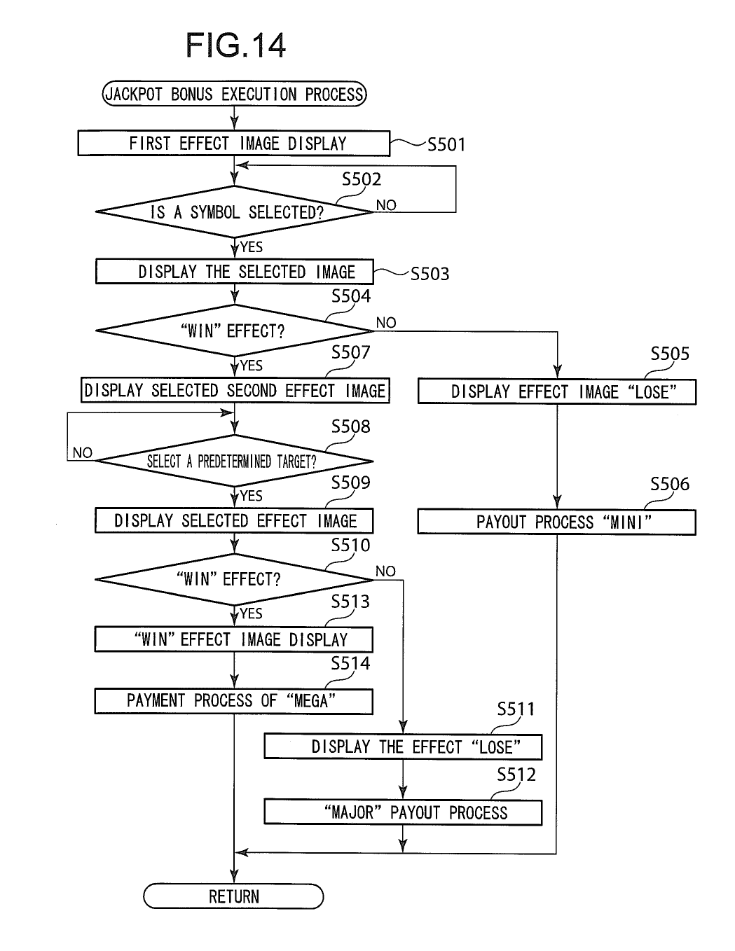

On the other hand, upon judging that the jackpot bonus trigger has been established (step S407: YES), the main CPU 41 executes a jackpot bonus game execution process described later with reference to FIG. 14 (step S408). In this jackpot bonus game, the main CPU 41 sequentially reads and executes the game programs or the like from the ROM 42 to execute the jackpot bonus game execution process. The main CPU 41 controls the process to shift to step S410 when terminating this process.

Next, the main CPU 41 judges whether or not a prize has been established (step S409). Specifically, the main CPU 41 judges whether or not a predetermined combination of symbols having been rearranged in the symbol matrix SM or numbers assigned to a rearranged symbol on a winning line corresponds to the input numbers. Here, the establishment of a prize means a fixed amount of the same symbol is rearranged, and also when a combination of numbers assigned to a rearranged symbol on a winning line corresponds to the combination of numbers stored in RAM 42.

Thereafter, upon judging that the prize has been established (step S409: YES), the main CPU 41 performs a coin-payout process in accordance with the number of coins set for the winning number (step S410: YES). Where the coins are deposited, the main CPU 41 executes a process for adding the number of paid-out coins to the credit amount stored in the RAM 43. On the other hand, in the coin-payout process, the main CPU 41 transmits the control signal to the hopper 66 to pay out the predetermined amount of coins.

On the other hand, upon judging that the prize has not been established (step S409: NO) or upon executing the processes at step S408 and step S410, the main CPU 41 sets the remaining free-game number B=B−1 (step S411). Specifically, the main CPU 41 sets B=B−1 at a value of the free-game number B stored in the RAM 43.

The main CPU 41 then judges whether or not a value of the remaining free-game number B is equal to zero (step S412). Specifically, the main CPU 41 judges whether or not a value of the remaining game number stored in the RAM 43 is equal to zero. Upon judging that the value of the remaining free-game number B is not zero (step S412: NO), the main CPU 41 controls the step to return to step S404.

On the other hand, upon judging that the value of B is equal to zero (step 412: YES), the main CPU 41 terminates the free-game execution process.

FIG. 14 is a flowchart showing a subroutine of the jackpot bonus game execution process invoked and performed at step S211 of the subroutine shown in FIG. 11 and at step S408 of the subroutine shown in FIG. 13, according to the first embodiment. At first, the main CPU 41 displays a first effect selection image (step S501). Specifically, the main CPU 41 displays the jackpot bonus game display image 90b displaying the start of the jackpot bonus game on the upper image display panel 33, and a selection screen for determining the types of jackpot bonus games in the display region 92 (see FIG. 7B).

Next, the main CPU 41 judges whether or not the symbol is selected (step S502). Specifically, the main CPU 41 judges whether or not the symbol displayed on the selection screen for determining the types of jackpot bonus games selected via the touch panel 69 (see FIG. 7B). Upon judging that a symbol has not been selected (step S603: NO), the main CPU 41 controls the current step to move to the process at step S607.

On the other hand, upon judging that the symbol is selected (step S502: YES), the main CPU 41 displays the selected effect image (step S503). Specifically, the main CPU 41 sequentially reads the effect image corresponding to the symbol selected at step S502 from the ROM 42 and displays the effect image in the display region 92 (see FIG. 8A).

Next, the main CPU 41 judges whether or not a “Win” effect is read (step S504). Specifically, the main CPU 41 judges whether or not the effect image read at step S503 corresponds to the “Win” effect. Upon judging that the read-out image does not correspond to the “Win” effect (step S504: NO), the main CPU 41 displays the effect image of “Lose” (step S505). Specifically, the CPU 41 reads the effect image corresponding to the effect image of “Lose” from the ROM 42, and displays the effect image in the display region 92 (see FIG. 8B). Next, the main CPU 41 executes a payout process of “Mini” (step S506). Specifically, the main CPU 41 executes a coin-payout process corresponding to a “Mini” payout. Where the coins are deposited, the main CPU 41 executes a process for adding the number of paid-out coins to the credit amount stored in the RAM 43. On the other hand, in the coin-payout process, the main CPU 41 transmits the control signal to the hopper 66 to pay out the predetermined amount of coins. The main CPU 41 terminates the jackpot bonus game execution process when executing the process at step S506.

On the other hand, upon judging that the “Win” effect is read (step S504: YES), the main CPU 41 displays a second effect selection image (step S507). Specifically, the main CPU 41 displays in the display region 92 a selection screen for determining a type of the jackpot bonus game, in a manner to make the symbol selected at step S502 identifiable.

Next, the main CPU 41 judges whether or not the predetermined symbol has been selected (step S508). Specifically, main CPU 41 judges weather or not symbols that were not selected in step S502 are selected via a touch panel 69. Upon judging that a predetermined symbols are not selected (step S508: NO), the main CPU 41 controls the current step to return to the process at step S508.

On the other hand, upon judging that the predetermined symbol has been selected (step S508: YES), the main CPU 41 displays an effect image corresponding to the selected symbol (step S509). Specifically, the main CPU 41 sequentially reads out of the ROM 42 the effect image corresponding to the symbol selected at step S502, and displays the effect image in the display region 92.

Next, the main CPU 41 judges whether or not a “Win” effect is read (step S510). Specifically, the main CPU 41 judges whether or not the effect image read at step S509 corresponds to the “Win” effect. Upon judging that the read-out image does not correspond to the “Win” effect (step S510: NO), the main CPU 41 displays the effect image of “Lose” (step S511). Specifically, the main CPU 41 reads from the ROM 42 the effect image corresponding to the effect image of “Lose”, and displays the effect image in the display region 92 (see FIG. 9A). Next, the main CPU 41 executes a payout process of “Major” (step S512). Specifically, the main CPU 41 executes a coin-payout process corresponding to a “Major” payout. Where the coins are deposited, the main CPU 41 executes a process for adding the number of paid-out coins to the credit amount stored in the RAM 43. On the other hand, in the coin-payout process, the main CPU 41 transmits the control signal to the hopper 66 to pay out the predetermined amount of coins. The main CPU 41 terminates the jackpot bonus game execution process when executing the process at step S512.

On the other hand, upon judging that the “Win” effect is read (step S510: YES), the main CPU 41 displays the effect image of “Win” (step S513). Specifically, the main CPU 41 reads from the ROM 42 the effect image corresponding to the effect image of “Win”, and displays the effect image in the display region 92 (see FIG. 9B). Next, the main CPU 41 executes a payout process of “Mega” (step S514). Specifically, the main CPU 41 performs the coin-payout process corresponding to “Mega”. Where the coins are deposited, the main CPU 41 executes a process for adding the number of paid-out coins to the credit amount stored in the RAM 43. On the other hand, in the coin-payout process, the main CPU 41 transmits the control signal to the hopper 66 to pay out the predetermined amount of coins. The main CPU 41 terminates the jackpot bonus game execution process when executing the process at step S514.

Next, a slot machine 100 according to a second embodiment will be described in detail with reference to the drawings. Here, the slot machine according to the second embodiment described below is a so-called hybrid type slot machine, which has a transparent liquid crystal panel allocated in front of a plurality of mechanical reels supported in a rotatable manner, and executes a game by displaying images of various types of symbols drawn on an outer peripheral surface of the mechanical reels through the transparent liquid crystal panel. The slot machine according to the second embodiment has an appearance, circuitry, and the like that are substantially the same as those of the slot machine 10 according to the first embodiment. Thus, a duplicated explanation is omitted here. In addition, the constituent elements corresponding to those of the slot machine 10 are designated by the same reference numerals and are explained.

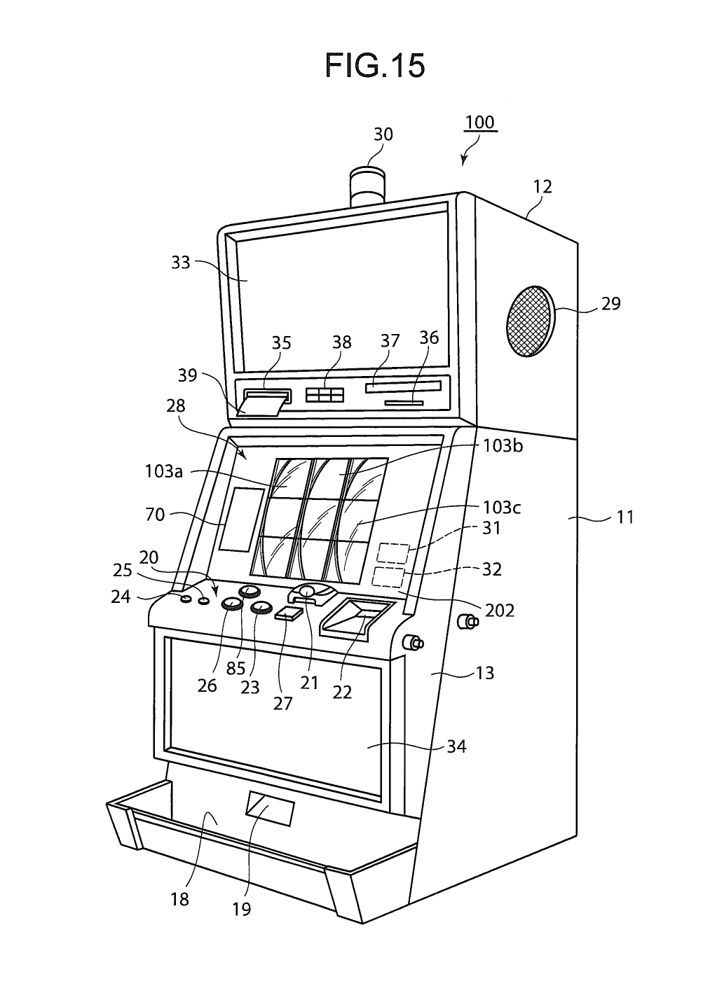

FIG. 15 is a view schematically depicting a frame format of an appearance of a slot machine according to a second embodiment. As shown in FIG. 15, the slot machine 100 is rotatably provided with three reels 101a to 101c. A symbol column made up of the symbols, “main character 121”, “sub character 122”, “office building 123”, “gold bullion 124”, “car 125”, “stock certificate 126”, “jet 127”, “villa 128”, and “stack of bills 129” is drawn on the respective one of the outer circumferential surfaces of the reels 101a to 101c.

A main liquid crystal panel 202 formed of a transparent liquid crystal panel, which is disposed at the main door, is provided in front of the respective reels 101a to 101c. The main liquid crystal panel 202 displays the symbol display region 28 with visually recognizable rear surface so as to surround symbols which were drawn on the reels 101a to 101c and displayed in a stopped state, respectively. The symbols drawn on the reels 101a to 101c are visualized by rendering the symbol display region 28 transparent.

In a symbol display region 28, symbols with plural types of numbers assigned, “main character 121”, “sub character 122”, “office building 123”, “gold bullion 124”, “car 125”, “stock certificate 126”, “jet 127”, “villa 128”, and “stack of bills 129” are rearranged.

Furthermore, a main liquid crystal panel 202 and an input display region 70 that displays an input combination of numbers displays a selection display image 71 which shows the desired symbol has been selected. Then, any of symbols “main character 121”, “sub character 122”, “office building 123”, “gold bullion 124”, “car 125”, “stock certificate 126”, “jet 127”, “villa 128”, and “stack of bills 129” are rearranged.

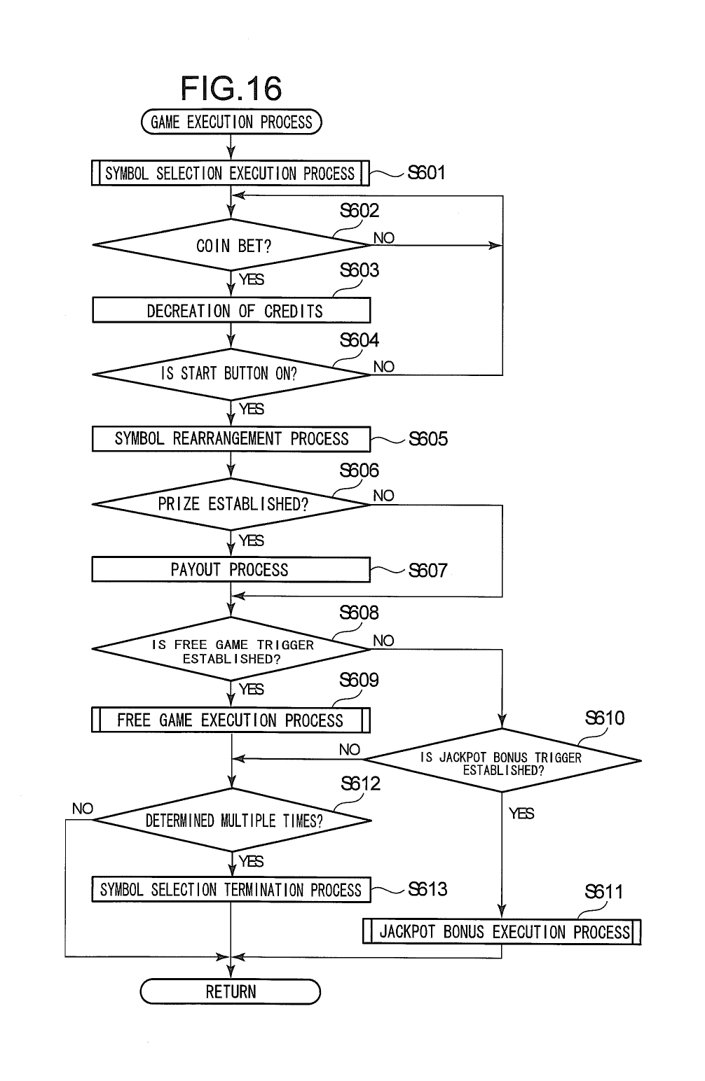

FIG. 16 is a flowchart showing a subroutine of the game execution process invoked and performed at step S102 of the subroutine shown in FIG. 10 according to the second embodiment. First, the main CPU 41 performs a symbol selection process (step S601). Specifically, main CPU 41 displays a symbol assigned with plural types of numbers for a combination of numbers to be input. Then a combination of numbers is displayed from the displayed symbols.

Next, the main CPU 41 judges whether a coin has been bet or not (step S602). Specifically, the main CPU 41 judges whether or not an input signal has been received, the signal being output from the 1-BET switch 26S when the 1-BET button 26 is pressed, or alternatively, being output from the MAX-BET switch 27S when the MAX-BET button 27 is pressed. The main CPU 41 controls the current step to return to the process at the step S602 upon judging that no coin has been bet (step S602: NO).

On the other hand, the main CPU 41 subtracts the number of bet coins from the credit amount stored in the RAM 43 (step S603) upon judging that a coin has been bet (step S602: YES). In the case where the number of bet coins is greater than the credit amount stored in the RAM 43, the main CPU 41 controls the current step to return to step S101 without performing the process for subtracting the number of bet coins from the credit amount stored in the RAM 43. In the case where the number of bet coins exceeds the upper limit (fifty coins in this embodiment) of coins that can be bet in one game, the main CPU 41 controls the process to shift to step S604 without performing the process for subtracting the number of bet coins from the credit amount stored in the RAM 43.

The main CPU 41 then judges whether or not the start button 23 has been set to ON (step S604). Specifically, the main CPU 41 judges whether or not an input signal has been received, the signal being output from the start switch 23S when the start button 23 is pushed. The main CPU 41 controls the step to return to step 604 upon judging that the start button 23 has not been set to ON (step S604: NO). Where the start button 23 has not been set to ON (for example, where an instruction has been input to terminate the game without setting the start button 23 to ON), the main CPU 41 cancels acceptance of a subtraction result at step S603.

On the other hand, upon judging that the start button 23 has been set to ON (step S604: YES), the main CPU 41 performs the symbol rearrangement process (step S605). Specifically, the CPU 41 executes the program stored in the RAM 43 and determines the symbols to be rearranged in the symbol matrix SM displayed on the lower image display panel 16. The symbols are determined from among the symbols, “main character 121”, “sub character 122”, “office building 123”, “gold bullion 124”, “car 125”, “stock certificate 126”, “jet 127”, “villa 128”, and the “stack of bills 129”. This determination is based on the symbol weighting data and random numeric values sampled by sampling the random numeric values in a numerical range which comes under a predetermined range of random numeric values. The CPU 41 then rearranges the symbols in the symbol matrix SM.

Next, the main CPU 41 judges whether or not a prize has been established (step S606). Specifically, the main CPU 41 judges whether or not a predetermined combination of symbols having been rearranged in the symbol matrix SM or numbers assigned to a rearranged symbol on a winning line corresponds to the input numbers. Here, the prize is established on condition that a predetermined number of symbols of the same type are rearranged in the symbol matrix SM and also on condition a combination of numbers assigned to symbols corresponds to a combination stored in RAM 42 (see FIG. 5).

Upon judging that the prize is established (step S606: YES), the main CPU 41 then executes a coin-payout process in accordance with the amount of bet and the number of coins set for the winning number (step S607). Where the coins are deposited, the main CPU 41 executes a process for adding the number of paid-out coins to the credit amount stored in the RAM 43. On the other hand, in the coin-payout process, the main CPU 41 transmits the control signal to the hopper 66 to pay out the predetermined amount of coins.

On the other hand, the main CPU 41 judges whether a free game trigger has been established or not (step S608) when judging that the prize is not established (step S606: NO) or executing the process at step S607. Specifically, the main CPU 41 executes the program stored in the RAM 43 to sample the random numeric values in a numerical range which comes under a predetermined range of random numeric values, thereby judging whether or not the free game trigger condition has been satisfied based on the sampled random numeric values. When a free game trigger condition is met (step S608: YES), during a free game execution process, the main CPU 41 sequentially reads and executes the game programs or the like and executes a free game process. Upon terminating this process, the main CPU 41 controls the step to move to step S612.

On the other hand, upon judging that the free game trigger has not been established (step S608: NO), the main CPU 41 judges whether or not a jackpot bonus game trigger has been established (step S610). Specifically, the main CPU 41 executes the program stored in the RAM 43 to sample the random numeric values in a numerical range which comes under a predetermined range of random numeric values, thereby judging whether or not the jackpot bonus game trigger has been established based on the sampled random numeric values. The main CPU 41 performs the jackpot bonus game execution process (step S611) when judging that the bonus game trigger has been established (step S610: YES). In this jackpot bonus game, the main CPU 41 sequentially reads and executes the game programs or the like from the ROM 42 to execute the jackpot bonus execution process.

On the other hand, the main CPU 41 judges whether or not the judgment of the correspondence of a combination of numbers has been initiated plural times (step S612), when judging that the jackpot bonus trigger has not been established (step S612: NO) or terminating the process at step S609. Specifically, the main CPU 41 judges whether or not a combination of symbols assigned with numbers corresponds to the input combination of numbers was judged plural times. The main CPU 41 terminates the game execution process when it is judged that judgments were not established plural times (step S612: NO).

On the other hand, upon judging that the judgments have been established plural times (step S612: YES), the main CPU 41 initiates a symbol selection termination process (step S613). During this symbol selection termination process, main CPU 41 stops displaying the combination of numbers on input display region 70 and numbers assigned on symbols “main character 121”, “sub character 122”, “office building 123”, “gold bullion 124”, “car 125”, “stock certificate 126”, “jet 127”, and “villa 128” input and stored in RAM 43 are cleared.

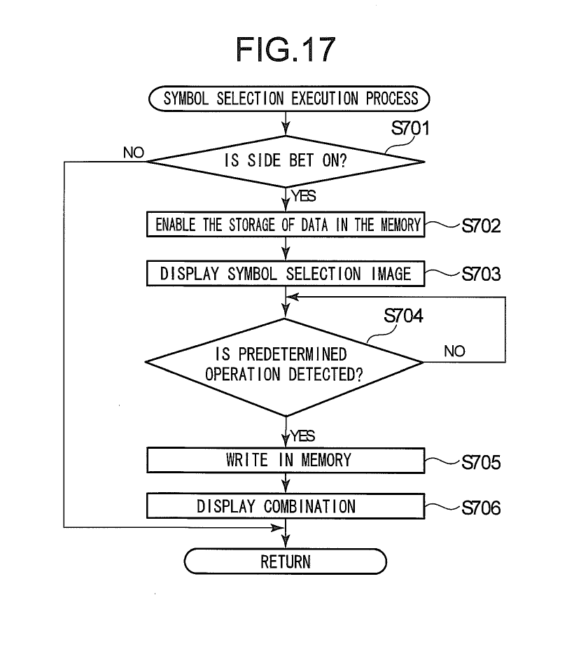

FIG. 17 is a flowchart showing a subroutine of the symbol selection execution process invoked and performed at step S201 of the subroutine shown in FIG. 11, according to the second embodiment. First, the main CPU 41 judges whether or not the side-BET has been set to ON (step S701). Specifically, the main CPU 41 judges whether or not an input signal has been received, the signal being output from the side-BET switch 85S when the side-BET button 85 is pushed. Upon judging that the side-BET button 85 has not been set to ON (step S701: NO), the main CPU 41 terminates the symbol selection process.

On the other hand, upon judging that the side-BET button 85 has been set to ON (step S701: YES), the main CPU 41 allows the memory to be writable (step S702). Specifically, main CPU 41 allows RAM 42 numbers that correspond to the plural types of numbers assigned to symbols via a touch panel 69

Next, CPU 41 displays symbol selection image (step S703). Specifically, the main CPU 41 rearranges symbols “main character 121”, “sub character 122”, “office building 123”, “gold bullion 124”, “car 125”, “stock certificate 126”, “jet 127”, “villa 128”, and “stack of bills 129”, for inputting numbers that correspond to the plural types of numbers assigned to symbol via the touch panel in any of symbol matrixes SM (see FIG. 4).

Next, the main CPU 41 judges whether or not the predetermined manipulation has been detected (step S704). Specifically, the main CPU 41 judges whether or not numbers assigned to symbols “main character 121”, “sub character 122”, “office building 123”, “gold bullion 124”, “car 125”, “stock certificate 126”, “jet 127”, “villa 128”, and “stack of bills 129” on rearranged on any symbol matrix SM via a touch panel 69 has been input. Upon judging that a predetermined process has not been detected (step S704: NO), the main CPU 41 controls the step to move to step S704.

On the other hand, main CPU 41 stores combinations of numbers (step S705) when a predetermined process has been detected (step S704). Specifically, the main CPU 41 stores the numbers assigned onto symbols “main character 121”, “sub character 122”, “office building 123”, “gold bullion 124”, “car 125”, “stock certificate 126”, “jet 127”, “villa 128”, and “stack of bills 129”, that were input in step S704 onto RAM 43.

Next, the main CPU 41 displays the combination (step S706). Specifically, main CPU 41 displays a combination of numbers that were stored in the memory display region 70 (see FIG. 4). The main CPU 41 terminates the symbol selection process when terminating this process.

While the embodiment according to the present invention has been described, the description presents only some of the specific examples and is not intended to limit the present invention in any way and specific constructions of each means and the like can be properly changed in terms of design. Moreover, the effects described in the embodiment of the present invention are only the most preferable effects generated from the present invention and the effects to be caused by the present invention is not limitative thereto.

What is claimed is:

1. A slot machine, comprising:
a display device having a display region for displaying plural types of symbols with plural types of numbers assigned thereto;
an input device for inputting numbers that correspond to the plural types of numbers assigned to the symbols;
a memory which stores a combination of the numbers inputted via the input device;
a display unit for displaying a combination of the numbers input by the input device;
a controller for controlling the display device, the input device, and the display unit;
the controller being programmed to:
(a) store in the memory a predetermined combination of the numbers inputted via the input device;
(b) execute a process of displaying the combination of the numbers stored in the memory on the display unit;
(c) execute a basic game;
(d) rearrange in the display region the plurality of symbols with plural types of numbers assigned thereto during the basic game;
(e) pay out a payment in a case where a combination of the rearranged symbols is a predetermined combination;
(f) pay out a payment, in a case where a combination of numbers assigned to the symbols rearranged on a winning line of the display region coincides with the combination of numbers stored in the memory.

2. The slot machine according to claim 1, comprising a BET button, which accepts input of a side BET, wherein:
the controller executes a process of displaying the numbers input by the input device on the display unit in a state in which the input numbers are writable in the memory on condition that the side BET is inputted from the BET button in the processes (a) and (b).

3. The slot machine according to claim 2, wherein:
the controller judges coincidence of combinations of the numbers in the process (f) while the symbols are rearranged for a plurality of times preset for a plurality of times preset as to input of a side BET of a predetermined credit by the BET button.

4. A slot machine according to claim 1, wherein:
the controller validates input of the BET button for randomly accepting the side BET during the basic game.

5. A slot machine according to claim 1, wherein:
the controller is programmed to:
(g) execute a free game during the basic game; and
(h) rearrange plural types of symbols to which the plural types of numbers are assigned, in the display region during the free game; and wherein the controller executes the process (f) during the basic game.

6. A slot machine, comprising:
a display device having a display region for displaying plural types of symbols with a plurality of numbers assigned thereto;
an input device for inputting numbers that correspond to the plural types of numbers assigned to the symbols;
a memory which stores a combination of the numbers inputted via the input device;
a BET button which accepts input of a side BET;
a display unit for displaying a combination of the numbers input by the input device;
a BET button which accepts input of a side BET;
a controller for controlling the display device, the input device, and the display unit and the BET button;
the controller being programmed to:
(a) store a predetermined combination of the numbers inputted via the input device in the memory on condition that the side BET is inputted from the BET button;
(b) execute a process of displaying the combination of the numbers stored in the memory on the display unit on condition that the side BET is inputted from the BET button;
(c) execute a basic game;
(d) rearrange in the display region the plurality of symbols with a plural types of numbers assigned thereto during the basic game;
(e) pay out a payment in a case where a combination of the rearranged symbols is a predetermined combination;
(f) pay out a payment, in a case where a combination of numbers assigned to the symbols rearranged on a winning line of the display region coincides with the combination of numbers stored in the memory.

7. The slot machine according to claim 6, wherein:
the controller judges coincidence of combinations of the numbers in the process (f) while the symbols are rearranged for a plurality of times preset as to input of a side BET of a predetermined credit by the BET button.

8. The slot machine according to claim 6, wherein:
the controller validates input of the BET button for randomly accepting the side BET during the basic game.

9. The slot machine according to claim 6, wherein:
the controller is programmed to:
(g) execute a free game during the basic game; and
(h) rearrange plural types of symbols to which the plural types of numbers are assigned, in the display region during the free game; and wherein the controller executes the process (f) during the basic game.

10. A slot machine, comprising:
a display device having a display region for displaying plural types of symbols with a plurality of numbers assigned thereto;
an input device for inputting numbers that correspond to the plural types of numbers assigned to the symbols;
a memory which stores a combination of the numbers inputted via the input device;
a display unit for displaying a combination of the numbers input by the input device;
a BET button which accepts input of a side BET;
a controller for controlling the display device, the input device, the display unit and the BET button.
the controller being programmed to:
(a) store a predetermined combination of the numbers inputted via the input device;
(b) execute a process of displaying the combination of the numbers stored in the memory on the display unit on condition that the side BET is imputted from the BET button;
(c) execute a basic game;
(d) rearrange in the display region the plurality of symbols with a plural types of numbers assigned thereto during the basic game;
(e) pay out a payment in a case where a combination of the rearranged symbols is a predetermined combination; and
(f) pay out a payment, in a case where a combination of numbers assigned to symbols rearranged on a winning line of the display region coincides with the combination of the numbers stored in the memory while a predetermined number of symbols are rearranged as to input of a side BET of a predetermined credit by the BET button.

11. The slot machine according to claim 10, wherein:
the controller validates input of the BET button for randomly accepting the side BET during the basic game.

12. The slot machine according to claim 10, wherein:
the controller is programmed to:
(g) execute a free game during the basic game; and
(h) rearrange plural types of symbols to which the plural types of numbers are assigned, in the display region during the free game; and wherein
the controller executes the process (f) during the basic game.
